(19) United States
(12) Patent Application Publication
(10) Pub. No.: US 2010/0153836 A1
(43) Pub. Date: Jun. 17, 2010

(54) Content rendering control system and method

(75) Inventors: Brad Krassner, Miami Beach, FL (US); Nikolai Mentchoukov, Miami Beach, FL (US); Alan Edwards, Miami Beach, FL (US); Igor Tchibirev, Miami Beach, FL (US)

Correspondence Address: Greenberg Traurig;Attn: M. Valcarcel, 1221 Brickell Ave., Miami, FL, 33131, US

(73) Assignee: Rich Media Club, LLC, Miami Beach, FL (US)

(21) Appl. No.: 12/316,781

(22) Filed: Dec. 16, 2008

(51) Int. Cl. G06F 17/00; G06F 17/30

(52) U.S. Cl. 715/234; 715/787; 707/E17.005; 707/E17.014

(57) ABSTRACT

A system and method for controlling of rendering of content via electronic networks, whereby content is rendered at a content page only when and to the extent that a pre-defined area of the content page is within the viewer's browser window dimensions and scrolling position, or within a pre-defined distance outside of said browser window dimensions and scrolling position. When a viewer accesses a content page and as the viewer scrolls up or down or left or right on the page, or increases or decreases the dimensions of the viewer's browser window, content that has been designated to render in the content page area corresponding to the viewer's then current browser window dimensions and scrolling position is rendered. Content relating to areas of the content page that are not within (or within such pre-defined distance from) the viewer's browser window dimensions and scrolling position unless or until such area is within such browser window dimensions and scrolling position or said pre-defined distance outside of same.

### BACKGROUND OF THE INVENTION

A. Technical Field

The present invention relates generally to methods and systems for content distribution via electronic communications networks. More specifically, the present invention is a system and method for controlling content rendering on a content page whereby content is rendered only when and to the extent that a predefined area of the content page, which can be the content page area where such content is to be rendered, is within (or within a predefined distance from) the viewer's browser screen dimensions and scrolling position.

B. Background

Internet web page content delivery typically involves a content viewer's use of a browser application that is installed in the viewer's computer which connects to the Internet, and through hypertext transfer protocol or “http” requests web pages from content servers. These web pages are generally written in Hyper Text Markup Language or “HTML.” When a content page is requested, the viewer's browser will download and assemble the web page according to the HTML instructions for the page, including commands from other languages that may be set in the HTML code, such as JavaScript or Ajax, and any images or rich media content that may be requested and loaded from the same server or other content servers. JavaScript is a scripting language that relies on a run-time environment, such as a browser application and can be used to write functions that are embedded or included in HTML pages and interact with the document object model of the page and can detect user keystrokes and other user actions. AJAX (an acronym for “Asynchronous JavaScript and XML”) is a web development technology that is used to implement web applications that communicate with a server in the background without interfering with the current state of the page.

This process has limitations due to the fact that the user's available browser window varies based on the display area and resolution settings of the user's personal computer or other communications device and that the browser may be expanded or reduced to any size or dimensions that the user dictates at any time. Web pages delivered to this varying environment generally have a set size and dimensions that are larger than the size and dimensions of the viewer's browser window displayed on a personal computer or other communications devices. As such, the browser window area often does not correspond in size with the web page area, and the user may have to scroll left or right or up or down to view all of the areas of the page. Also, the nature of HTTP protocol dictates that the code must be completely interpreted by the browser before it can display the page. Because of these limitations, when a web page is requested by a user, the entire web page, no matter how big, must be loaded and rendered by the browser, even if that web page extends far beyond the dimensions of the individual viewer's available browser dimensions and scrolling position. This is extremely inefficient in bandwidth and CPU utilization, and also affects the potential accuracy of the data pertaining to actual perception of delivered content used for various purposes, including, but not limited to, proper accounting of advertising content usage and placement charges and the measurement and reporting of meta data related to the content delivered.

Advertising and content delivery for traditional media to date has been made based on the fact that all of the content is available to the viewer at any given time. When a newspaper page is printed or a radio show or television show is broadcast, all of the content is delivered and available to the viewer. Even with traditional print media, although a viewer may fold a page and not see portions of it, the entire page is available to view. All broadcasting and reporting measurements are based on this given fact. With the advent of the Internet, for the first time a medium was created where significant portions of the content are actually not available to the viewer unless the viewer takes some sort of action to get to the content. This action in most cases is the scrolling of the page via the browser mechanism or expanding the browser area to make more of the web page available.

Pay Per View, or Cost Per Thousand Views (CPM) billing and broadcasting measurements related to the Internet follow the assumption that the content is always available to the viewer when the viewer is on the requested page. The loading of a web page does not guarantee all of its content will be in view or available to a viewer for interpretation or influence. Nevertheless, content usage and placement fees are usually charged even for content that a viewer may actually never have viewed based on the rationale that because the entire web page can be loaded and viewed if the user takes appropriate action that the entire page, all of its content is “available” to the viewer. This is not an accurate assessment of whether content was actually perceived by a viewer.

### SUMMARY OF THE INVENTION

The present invention is a system and method for delivering and rendering content automatically and only when and/or to the extent that a pre-defined area of the content page is within the viewer's browser window dimensions and scrolling position, or within a pre-defined distance from the viewer's browser window dimensions and scrolling position. As used herein, the term “render” or “rendering” refers to the process of requesting and loading content so that it may be viewed, heard or otherwise perceived by a viewer communicating electronically using a browser. The pre-defined area, designated by the content page administrator to trigger rendering, is referred to below as the “content page triggering area.” In a preferred embodiment, the pre-defined area of the content page referred to as the “content page triggering area” is the designated content page area where the content is to be rendered. In other embodiments the content page triggering area can be an area of the content page other than the area where the content will be rendered. The system can be configured to trigger rendering of content in a designated content page rendering area when the pre-defined content page triggering area is within the dimensions and scrolling position of a viewer's browser window, or alternatively, when the pre-defined content page triggering area is within a pre-defined distance outside of the viewer's browser screen dimensions and scrolling position. The system includes an interface for receiving content page address, content file information (which may be in the form of instructions to retrieve one or more content files stored in a content server or other storage device, which may be either part of the system-end components or remotely located components), content page rendering area and content page triggering area parameters and other content page data from content page administrators, and a system server with a database for storing one or more records containing such data, each record being given an identification code. The system software application generates a single tag based on said content page data, and the tag is placed on the content page. The tag includes the identification code for the corresponding record with content page data stored in the system database and a link to a system server-side application. When a viewer requests the designated content page, the tag is activated and links to the system server-side application. The system server-side application then collects data from the request, including, but not limited to, the address of the content page and the viewer's network address (for example, the Internet Protocol address associated with a viewer computer when the network is the Internet), and retrieves the corresponding record containing content page data stored in the system server database, and generates code, preferably JavaScript code, referred to herein as a “correlator code,” which is written to or otherwise embedded on the content page and interacts with the viewer's browser. The correlator code can be positioned anywhere on the content page, not necessarily the location on the content page where the particular content will be rendered. A unique identification code is then assigned to the particular viewer/browser which can be created by the correlator code itself, or can be created by the system server-side software application and be retrieved from cookies or from the system database. The correlator code collects additional information from the viewer's browser, including, without limitation, the viewer's operating system and browser type/version, and a list of other content that was already rendered on the page to prevent duplication of the same content on the content page, among other data and preferably also indexes the page for content. The correlator code dynamically generates HTML code on the content page for a layer to be used as a marker for the content page area where the content will be rendered. The system correlator code then generates a query string link including the data collected via the correlator code and server-side application and the query string link is stored as a variable on the content page. The correlator code periodically checks viewer browser screen coordinate data from the viewer's browser application with content page coordinates for the pre-defined content page triggering area (which may be the same area as the content rendering area). As a viewer scrolls through a content page (whether up and down or left and right) or the viewer's browser window dimensions change, the correlator code periodically checks data from the viewer's browser regarding the viewer's browser window scrolling position and dimensional coordinates and when there is correspondence between the browser window dimensional and scrolling position coordinates and the coordinates for the content page triggering area (which may be partial correspondence or full correspondence, or correspondence with coordinates that are a pre-defined distance outside the viewer's browser dimensional and scrolling position coordinates), the query string link is activated, the correlator code dynamically generates HTML code and tags inside the previously generated HTML marker where the content will be rendered and the content is rendered in the designated content page rendering area. The correlator code also records at the display page data retrieved from the viewer's browser regarding the rendering of the content. The correlator code is preferably JavaScript code, although the invention is not limited to use of JavaScript; other scripting or compiling languages can be used, such as, without limitation, JScript, ECMAScript or other scripting capable of generating code that determines whether or not the specified content page triggering area is within, or within a pre-defined distance outside of, the dimensions and scrolling position of a viewer's browser window. The correlator code contains all of the necessary variables and functions to execute the correlation process described above in conjunction with the viewer's browser. The correlator code is code delivered in the form of source code that interprets and executes the script accordingly by the browser application of the viewer although it resides on the content page itself. It is not an applet or other compiled file or self executing software application. Content is only rendered on a content page to a viewer when and/or to the extent that the pre-defined content page triggering area is within, or within a pre-defined distance outside of, the viewer's browser screen dimensions and scrolling position. In a preferred embodiment, the pre-defined content page triggering area is the area of the content page where the content is to be rendered, and content to be rendered in the pre-defined area of the content page is not rendered unless and until the particular area of the content page is within the viewer's browser screen dimensions and scrolling position, or within a pre-defined distance outside of the viewer's browser screen dimensions and scrolling position. With the present invention bandwidth and other communications resources are utilized more effectively and efficiently.

Reports regarding the delivery and rendering of content can be generated by the system for use by system users and third party content providers and content publishers (e.g., web pages) to better analyze the effectiveness of their content distribution. Unlike other systems, the present invention enables precise and accurate accounting of what content actually appears within in a viewer's browser window dimensions and scrolling position area and enables analysis of content rendering activity with respect to particular areas of a content page, i.e., which areas are most active with regard to content rendering to viewers, enabling effective content placement page organization schemes and content placement fee structures based on rendering activity for the particular content display area of a content page relative to other areas of the page and the viewer's browser window dimensions. In one embodiment, the invention gathers information to better deliver content loaded, including reach, frequency, viewer's geographic location, the demographics of the viewership, among other data, allowing websites to effectively provide content on their web pages on an as needed basis and then to utilize the information in myriad ways. With the present invention, content placed in any designated web page area, including but not limited to, below the fold areas of a web page, can be loaded as needed, and its usage/rendering can be reported and billed only if the viewer scrolls them into the available area of their browser window, and when response rates are calculated against the ads loaded and rendered.

The present invention gives content publishers, by adding a single JavaScript tag on their content pages and specifying a predefined area on the content page which, when its coordinates correspond in a pre-defined manner with coordinates of the viewer's browser dimensions and scrolling position, triggers content rendering at the content page, the ability to provide to viewers of their pages a variety of content including promotions, video promotions, advertising and third party network advertising on their web pages and deliver this content to the page when and/or only to the extent that the pre-defined content page triggering area of the content page is within, or within a pre-defined distance outside of, the then current dimensions and scrolling position of the viewer's browser window. The tag includes a link to a system server software application that triggers the rendering of content within the designated content rendering area of a content page and causes the content page to retrieve content rendering activity data from the viewer's browser. The present invention, in one embodiment, may then trigger several actions, including an indicator to show the viewer or system users that the content is rendered and available, and report with accuracy whether or to what extent the content page area where particular content is to be rendered is within the available area of viewer's browser window, for how long the content was available to trigger further action, how many unique viewers were presented the content (reach), the amount of times each unique viewer was presented the content (frequency) the general geographic location of the viewer, the browser version used by the viewer, what actions were taken on the advertisement in the form of clicks, the click rate in relation to the number of views, and other meta data in relation to the rendered content. The content can be successively rendered automatically to the viewer as the viewer scrolls through a content page, with the effects of instant rendering attracting the attention of the viewer.

The present invention also allows content publishers (e.g. content page administrators), by placing a single JavaScript tag on their content page where content is to be rendered to generate accurate reports to analyze their content according to different areas of their content pages and how they relate to the available areas of viewer's browser windows, enabling accurate accounting and reporting of content rendering and viewer content page viewing and scrolling characteristics, providing insights as to what display areas of a content display site are most effective for content display. The reports consist of accurate data of their pages, and how often they become available to a viewer within their browser window. Content pages are, in one embodiment, divided into four areas, top, above the fold, below the fold, and bottom, although further division is programmable as desired. The data for each area is based on the collected rendering activity data from the rendering of content in the specified area of the content page.

In a preferred embodiment, the computer and communications network is the Internet, the content display sites and pages websites and web pages, and content page administrators may be web page administrators, but the present invention is not limited to any particular communications network or content display site. The content can be stored at a network location other than the content display site server, such as, for example, one or more content file servers, which can be remotely located, with the instructions being stored in the system database to execute and render the content at the specified rendering area on a content page when requested.

The present invention, in a preferred embodiment, allows content page administrators to divide their content display site pages into one or more content rendering areas. Content page administrators interact with the system to designate such content rendering areas, specifying their position and size and designating content files to be rendered thereat. The system processes the specified information and provides a JavaScript tag that includes the identification code for the system server database record storing the content page information provided by the content page administrator and includes a link to a system server-side application at the system server. When the viewer requests the particular content page, the JavaScript tag links to the system server-side application and the system server-side application retrieves data from the viewer's request as well as the record with data for the particular content page and generates code, referred to as a “correlator code” which is preferably JavaScript code, that dynamically creates HTML code on the content page for an HTML layer to be used as a marker for the content page area and also correlates the pre-defined content page triggering area with viewer browser window scrolling position and dimensions, and the system server-side application generates a query string link which is stored as a variable on the content page, including data collected from the viewer's browser via the correlator code. As the viewer scrolls through the content page, the correlator code determines whether the browser scrolling position and dimensional coordinates correspond with content page coordinates for the pre-defined content page triggering area on the content page, (which may be the area on the content page where the content is to be rendered or any other pre-defined area of the content page) and when browser window and the pre-defined content page triggering area's coordinates correspond (the correspondence can be customized and pre-defined as well, and can be partial correspondence, full correspondence or correspondence with coordinates that are a pre-defined distance outside of the viewer's browser window dimensional and scrolling position coordinates), the query string link stored on the page is triggered and the content designated for rendering at or in relation to such content page area is retrieved, assembled and rendered in the designated content page rendering area. The specified content is rendered only if and when such pre-defined content rendering area is determined by the correlator code to be within, or within a pre-defined distance outside of, the dimensions and scrolling position of the viewer's browser window. When the pre-defined content page triggering area is the area where the content is to be rendered, the content is rendered only when and/or to the extent that the area of the content page where the content is to be rendered is within, or within a pre-defined distance outside of, the dimensions and scrolling position of the viewer's browser window.

The system database storing the records with content page data is preferably a relational database, housed preferably in a system-end server. Each such record has a unique identifier. The system server-side software application contains all code that is necessary to communicate with the system server database as well as with the content page and generate the correlator code which is written to or otherwise embedded on the content page and interacts with the viewer's browser to control the triggering of content requesting and rendering when the pre-defined content page area where the content is to be rendered is within, or within a pre-defined distance outside of, the dimensions and scrolling position of a viewer's browser window. The JavaScript tag placed on the content page for the particular content rendering area consists of a tag placed somewhere on the content page containing a link to the system server-side software application and an encrypted ID for the applicable content page record stored at the system database located preferably at the system server. When a viewer requests the particular content page, the request activates the link to the system server-side application, which retrieves the record with data corresponding to the encrypted id for such record included in the tag and retrieves viewer browser data from the page request itself. The system server-side application generates the custom correlator code to be written to or otherwise embedded on the content page. The correlator code then creates HTML code on the content page to serve as a marker for the content page area where the content will be rendered. The correlator code collects information from the viewer's browser additional information, which may include information regarding the viewer's computer system, browser type/version, and information regarding content that has previously been rendered on the content page to prevent duplication of content on the page, among other data, and also collects and indexes data pertaining to text on the content page. A unique identification code is then assigned to the particular viewer/browser which can be created by the correlator code itself, or can be created by the system server-side software application and be retrieved from cookies or from the system database. The unique identification code assigned to the particular viewer/browser can be created by the correlator code itself, or can be created by the system server and retrieved from cookies or from the system database. The correlator code creates a query string link with the information collected by the correlator code attached thereto and the query string link is stored as a variable on the content page. When the pre-defined content page triggering area is within, or within a pre-defined distance outside of, the dimensions and scrolling position of the viewer's browser screen, the correlator code triggers the query string link that is stored on the page and dynamically generates HTML code and tags inside the previously created HTML marker where the content will be rendered and the content is rendered in the designated content page rendering area. The JavaScript code on the content page contains the variables and commands to continuously determine what content page area(s) is/are within, or within a pre-defined distance outside of, the dimensions and scrolling position of the viewer's browser, causing the designated content to be rendered in such event and retrieving content rendering activity data from the viewer's browser.

### BRIEF DESCRIPTION OF THE DRAWINGS

All of the figures depict preferred embodiments although other embodiments are contemplated and the present invention is not limited to the embodiments shown.

FIG. 1 is a diagrammatical overview of the interplay and overlap of a viewer's screen display area, browser application, browser window and content page.

FIG. 2 is a diagrammatical representation of system components and their interrelationship with content page administrators, viewers and communications network(s).

FIG. 3 is a diagrammatical overview of the communication flow among system components, content page administrators and website viewers.

FIG. 4-A is a process flow diagram showing the process flow of the present invention.

FIG. 4-B is a continuation of a process flow diagram showing the process flow of the present invention.

FIG. 4-C is a continuation of a process flow diagram showing the process flow of the present invention relating to an embodiment utilizing a content rendering module.

FIG. 5 is a diagrammatical representation of the communication between system components in an embodiment using a content rendering module.

FIG. 6 depicts a sample system content site administrator user registration screen.

FIG. 7 depicts a sample system content site administrator user login screen.

FIG. 8 depicts a sample system user site registration screen showing data entry relating to content page title, uniform resource locator address and optional logo image.

FIG. 9 depicts a sample user registration screen whereby content page administrators enter their content page's primary audience geographic location.

FIG. 10 depicts a sample user registration screen whereby content page administrators enter their content page's content type.

FIG. 11 depicts a sample user registration screen whereby content page administrators enter their content page audience demographic data.

FIG. 12 depicts a sample content page registration confirmation screen.

FIG. 13 depicts a sample content page rendering area creation screen.

FIG. 14 depicts a sample content page rendering area dimension selection screen.

FIG. 15 depicts a sample content page rendering area dimension specification screen.

FIG. 16 depicts a sample screen wherein a JavaScript tag with link to the system server-side application is generated for content page administrators to copy and paste into the page code of the content page in which the designated content page rendering area resides.

FIG. 17 depicts a sample content page with the content rendering area of the content page located below the viewer's browser window dimensions and scrolling position, noted by an oval indicator.

FIG. 18 depicts a sample content page with the content rendering area entering the viewer's browser window dimensions and scrolling position, noted by an oval indicator.

FIG. 19 depicts a sample content page with the content rendering area fully within the viewer's browser window dimensions and scrolling position.

FIG. 20 depicts a sample content page with the content rendered and an indicator showing the time that the content has been rendered.

FIG. 21 depicts a sample content page with the content rendering area partially outside of the viewer's browser window dimensions and scrolling position.

FIG. 22 depicts a sample system content page data report screen.

FIG. 23 depicts a sample system content rendering area data report screen.

FIG. 24 depicts a sample system content rendering area activity report screen.

FIG. 25 depicts a sample system content rendering area data report screen.

FIG. 26 depicts a sample system content rendering activity report screen.

FIG. 27 depicts a sample system viewer browser type data report screen.

FIG. 28 depicts a sample system viewer geographic location report screen.

FIG. 29 depicts a sample content rendering area activity report screen.

FIG. 30 depicts a sample content rendering time data report screen.

FIG. 31 depicts a sample content page using the system to determine viewer browser screen dimensions and scrolling position to provide scaled rendering of content.

FIG. 32 depicts a sample content page showing content rendered scaled to a predefined size in relation to the viewer's browser window dimensions and scrolling position.

FIG. 33 depicts a sample content page showing content re-rendered and re-scaled to a predefined size in relation to modified viewer browser window dimensions and/or scrolling position.

### DESCRIPTION OF A PREFERRED EMBODIMENT OF THE INVENTION

According to a preferred embodiment hereof, the present invention is a system and method for controlling the rendering of content on content pages via electronic communications networks, whereby content is rendered only if and/or to the extent that a designated portion of the content page area (the “content page triggering area”) is within, or within a pre-defined distance outside of, the viewer's browser window dimensions and scrolling position. The pre-defined content page triggering area can, in a preferred embodiment, be the area of the content page where the content is to be rendered. Content is requested, delivered and rendered automatically and sequentially for pre-defined areas of the content page that come within the dimensions and scrolling position of the viewer's browser window as the viewer scrolls across or down the content display site page without further viewer click action or other action being required. Furthermore, content can be controlled to rendered only when and to the extent that the viewer's browser window area corresponds with content page area where particular content is to be rendered rather than rendering an entire content page when only a portion is within the viewer's browser window dimensions and scrolling position, resulting in greater efficiency in bandwidth and other communications resource utilization. In a preferred embodiment, the computer and communications network is the Internet and the content display sites are websites, but the present invention is not limited to any particular communications network or content display site.

The system of the present invention in a preferred embodiment is a system for controlling the rendering of content via an electronic communications network at a designated content rendering area of a content page to one or more viewers having a network communications device with a browser software application with adjustable window dimensions and scrolling position, for viewing content pages within said browser's window dimensions and scrolling position, comprising: a system-end computer equipped and configured for communications via said electronic communications network, including one or more computer processing units and means for communicating with one or more content pages that have one or more of said content rendering areas and one or more content page triggering areas on said pages, and a system server including a database that stores one or more records containing data pertaining to said one or more content pages, said one or more content page triggering areas, said one or more content page rendering areas and said one or more content files, one or more content file servers which house one or more content files, one or more network communications interface software applications for receiving from system users data designating one or more content pages, one or more content page rendering areas within said one or more content pages, one or more content page triggering areas that, when determined to be within, or within a pre-defined distance outside of, a content page viewer's browser window dimensions and scrolling position, will result in content being rendered in said content page rendering area, and one or more content files for rendering at said one or more designated content rendering areas of said one or more content pages; and for creating a file, for storage in said system server database, that contains said data, assigning an identification code to said data record and generating a tag/link to be placed on said one or more content pages, said tag/link including a reference to said data record identification code and a link to a system custom software application; and one or more system custom software applications for generating and writing to or otherwise embedding on said designated content page a correlator code to determine when said designated content page triggering area is within, or within a pre-defined distance outside of, a content viewer's browser window dimensions and scrolling position, for dynamically generating HTML code to be used as a marker for said designated content page rendering area, and for communicating with said correlator code to cause said one or more content files to be rendered in said one or more content page rendering areas when said correlator code detects that said designated content page triggering area is within, or within a pre-defined distance outside of, said content viewer's browser window dimensions and scrolling position.

The system includes computer processing means such as one or more conventional computer processing units and microprocessors and one or more Internet or other network communications interface software applications for interfacing with system users (which are typically content page administrators) providing a graphical user interface for system users to enter data regarding their content page(s), and designation of the content page triggering area(s) that will trigger content rendering when such content page areas are within, or within a pre-defined distance outside of, the viewer's browser window dimensions and scrolling position, and content files to be rendered. Content display sites can access the system and enter registration information and provide instructions to cause content to be rendered at specified areas of their content pages, and/or when specified areas of their content pages are within, or within a pre-defined distance outside of, the viewer's browser window dimensions and scrolling position, and obtain a JavaScript tag and link for placement on the content page where the content will be rendered, which tag establishes communications with the system side server when a viewer initially requests the particular content page. The system server-side application receives the JavaScript tag request, retrieves from the system database the data record corresponding to the requested page and retrieves viewer and browser address and other data from the viewers' browser request itself, and generates the custom correlator code to control content rendering to render content when and/or only to the extent that the pre-defined area of the content page is within, or within a pre-defined distance outside of, the viewer's browser screen dimensions and scrolling position. The correlator code is generated for each viewer's request of the particular content page and is customized for each viewer in that its functioning is tied to each specific viewer's browser window dimensions and scrolling position. The correlator code is written to or otherwise embedded on the content page. The correlator code determines whether the page coordinates of the pre-defined area of the content page correspond with the coordinates of the viewer's browser window dimensions and scrolling position. The correspondence may be partial or full or can be correspondence with coordinates that are a pre-defined distance outside of the viewer's browser window dimensional and scrolling position coordinates. The correlator code then generates HTML code on the content page for an HTML layer to be used as a marker for the content page area where the content will be rendered. When the pre-defined content triggering page area is also the area of the page where content is to be rendered, the content can be rendered at the specified content page area only when the correlator code determines that the designated pre-defined area of the content page is within, or within a pre-defined distance outside of, the viewer's browser screen dimensions and scrolling position. The correlator code periodically determines whether there is any correspondence between content page area coordinates and browser screen dimension and scrolling position coordinates and when the required correspondence is detected (which may be partial or full correspondence, or correspondence with coordinates that are a pre-defined distance outside of the viewer's browser window dimensions and scrolling position, as desired and as designated by system users or as programmed into the system), the correlator code prints HTML code and tags inside the previously created HTML marker and activates the query string link to cause the content to be retrieved and rendered, or other action to be triggered. Viewers can access content sites and content pages by existing or future means, such as via a viewer-end computer configured and equipped for Internet and communicating with said content display site. The electronic communications network used can be one or more of multiple network types, such as, without limitation, networks of computers communicating via common protocols such as the Internet, as well as cellular, wireless, cable, satellite, power line or other networks or combinations of such networks. Viewer-end communication devices can be a typical microprocessor-based desktop or laptop computer, or a personal digital assistant wireless phone or other electronics network communication device, typically having a microprocessor supported by a read only memory, a random access memory and input and output devices such as display screens and keyboards/keypads, capable of running a browser application. Viewers access the particular network typically via a telecommunications service provider (e.g. an Internet service provider) and use a browser application to access websites.

The content files are not limited to any particular form, and may be static HTML images or rich media files such as .swf. The content files are preferably stored at a content server. The interface means, processor means and computer communications means can have various embodiments, including, without limitation, use of traditional Internet browser applications.

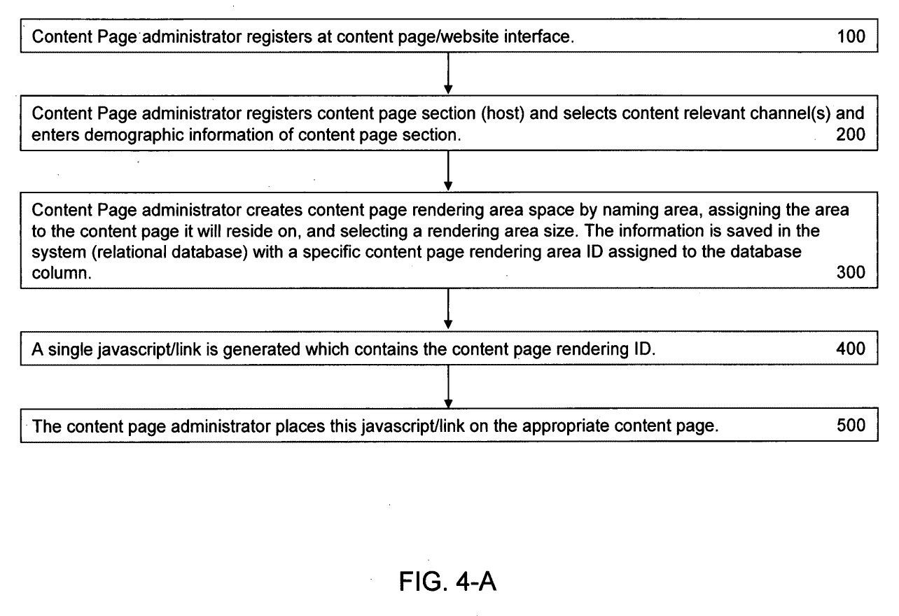

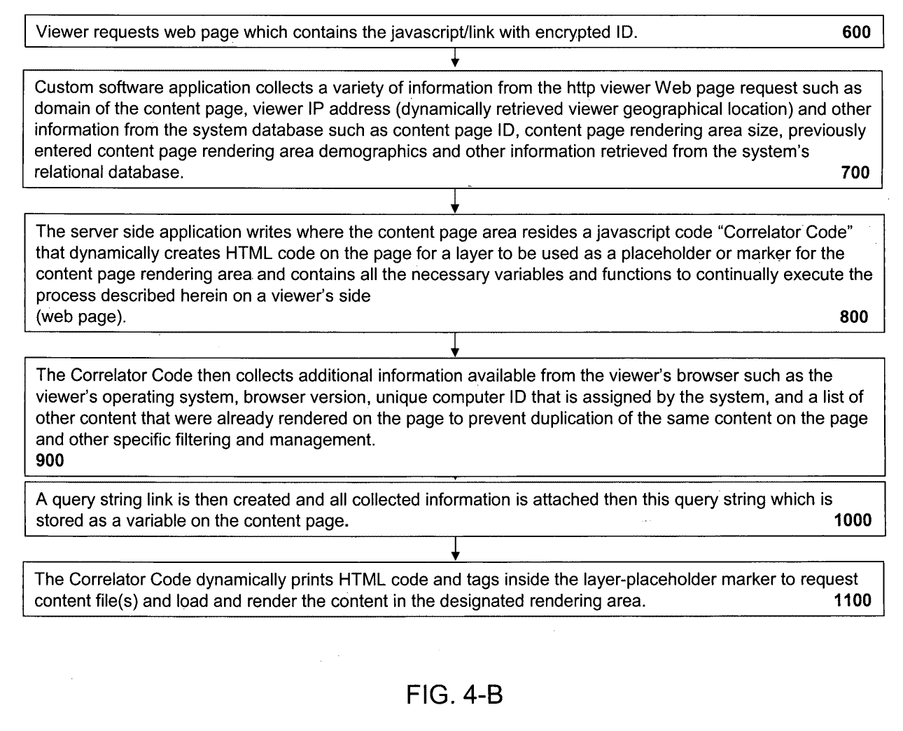

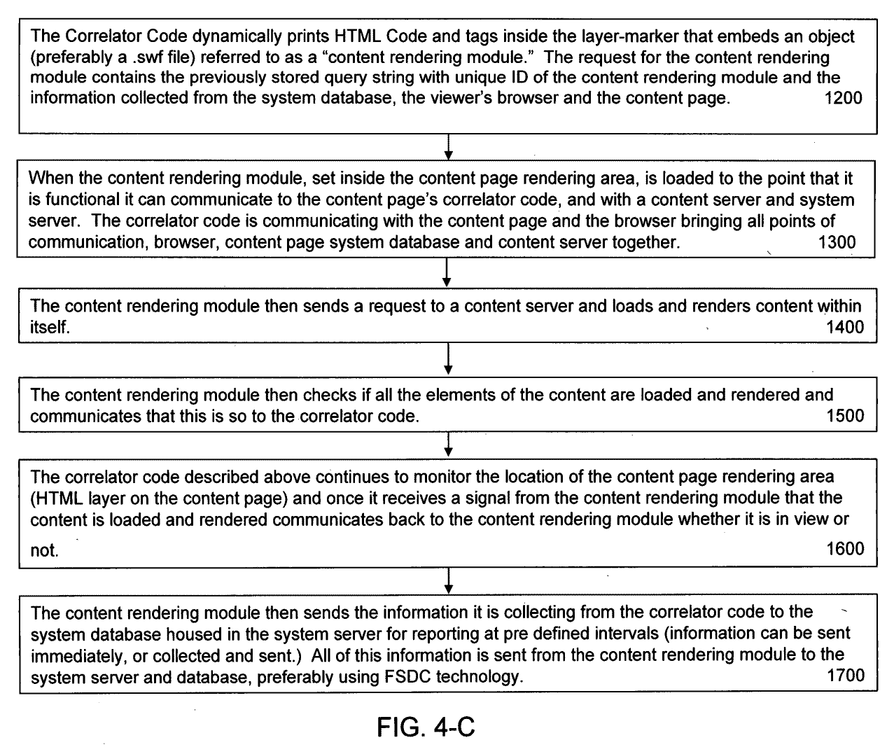

The method of the present invention in a preferred embodiment comprises the steps of: designating one or more content pages, one or more content page triggering areas, one or more content page rendering areas and content files previously stored in electronic file format in a mass storage device of a computer system for rendering at said designated content page rendering area of said content page or other network location; storing as a record within a system-side database data pertaining to said content page, content page triggering area, content page rendering area and content file (the content page and the content file(s) can reside on servers other than the system server); generating and writing to or otherwise embedding on the designated content page a tag/link that when activated by a content page viewer request of the designated content page, links to a system server-side application and retrieves, via said server-side application, data from said record stored in said system server-side database and data pertaining to said viewer and viewer browser from said content page request, and generating and placing a correlator code on the designated content page which determines whether said content page triggering areas of the content page is within, or within a pre-defined distance outside of, the viewer's browser window dimensions and scrolling position; said correlator code then generating an HTML layer to serve as a marker for the designated content page rendering area where the designated content is to be rendered, generating a query string and link for placement at the content page, which when activated by the correlator code based on detection that the designated content page triggering area is within, or within a pre-defined distance outside of, the dimensions and scrolling position of the viewer's browser window, dynamically generates HTML codes and tags to render the designated content in the designated content page rendering area of the content page. FIGS. 4-A, 4-B and 4-C, discussed further below, depict the process flow of the method in a preferred embodiment.

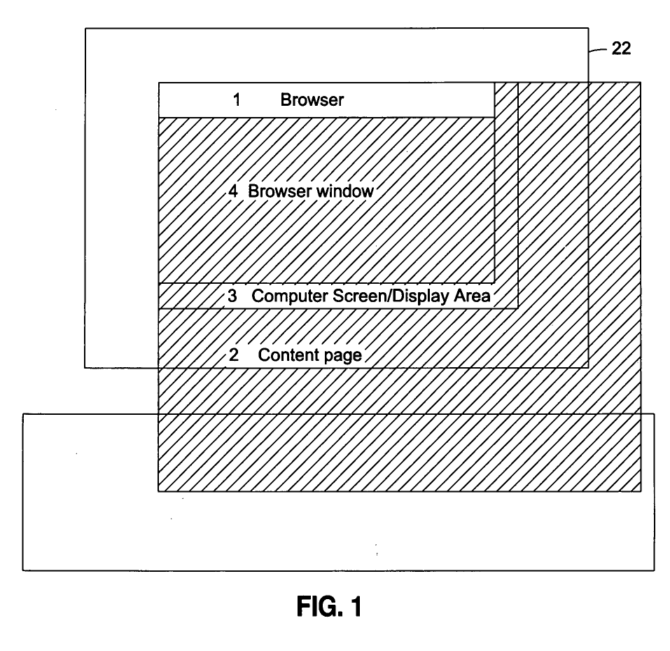

Referring to FIG. 1, which depicts a diagrammatical overview of the interplay and overlap of a viewer's screen display area, browser application, browser window and content page, there is a content display page 2 with space on its pages for content to be rendered, which appears within a browser window 4, a portion of which is within the viewer's display screen area 3. As can be seen, the content page is larger than the browser window, so not all of the content page area is within the browser window dimensions and scrolling position shown on the viewer's display screen. The present invention can control rendering of content so that only the content that is designated to render when a pre-defined area within the content page area is within, or within a pre-defined distance outside of, the viewer's browser window dimensions and scrolling position is rendered, and so that rendering occurs only when such pre-defined content page triggering area is within, or within a pre-defined distance outside of, the viewer's browser window dimensions and scrolling position.

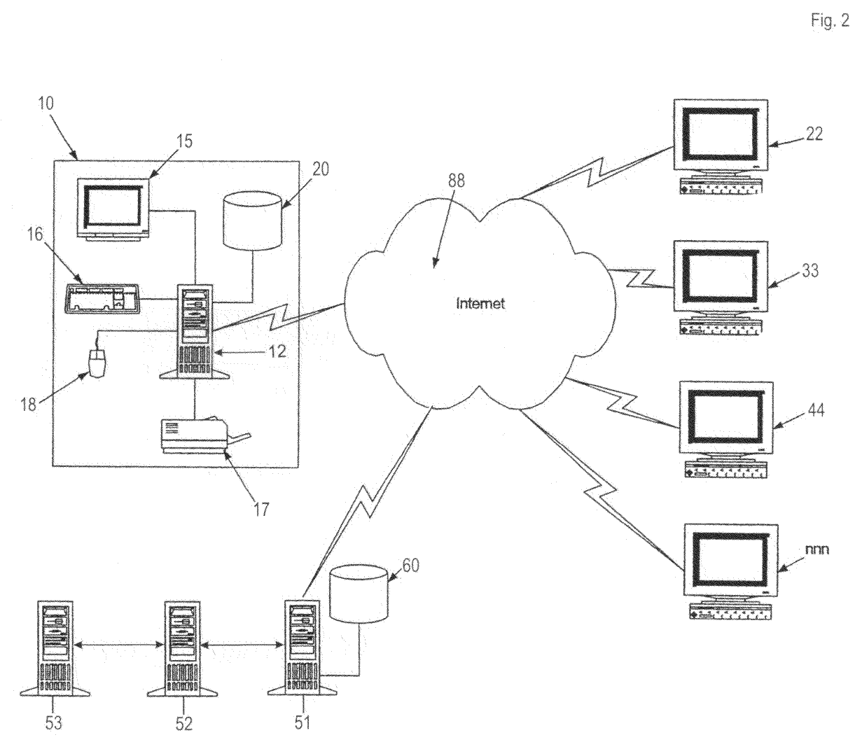

Referring now to FIG. 2, an overview of a preferred embodiment of the present invention is shown. The present invention interacts with one or more content page viewer computer systems or other communications devices having a browser application 22, 33, 44 and nnn, and communicating via the Internet 88 with the content page computer system 10. The content page computer system 10 comprises a content page server 12 and file storage device 20 as with the typical Internet client-server model utilizing HTTP. HTTP is a known application protocol that provides users access to content in different formats such as text, graphics, images, sound, video, as well as programs. HTML is a standard page description language which provides basic document formatting and allows the programmer to specify links to other servers and files. Links are specified via a Uniform Resource Locator or URL. Upon specification of a link, the client makes a TCP/IP request to the server and receives information that was specified in that URL (for example another Web page that was formatted according to HTML) in return. The information returned may be generated in whole or in part by a program that executes on the server. Such programs are typically known as Common-Gateway-Interface scripts and can be written using known programming languages or methods that the server supports. A typical Web page is an HTML document with text, “links” that a user may activate (e.g. “click on”), as well as embedded URLs pointing to resources (such as images, video or sound) that the client must fetch to fully render the Web Page in a browser. These resources may not be located on the same server that the HTML document was sent from. Furthermore, HTTP allows for the transmission of certain information from the client to a server. This information can be embedded within the URL, can be contained in the HTTP header fields, or can be posted directly to the server using known HTTP methods. Both the viewer and the content page administrator can communicate with the system via various input and output devices, as is well-known in the art. For example, the computer system 10 preferably comprises a display screen or monitor 15, a keyboard 16, a printer 17, a mouse 18, among other devices. The computer system 10 is preferably connected to the Internet 88 that serves as one preferred communications medium. The Internet 88, as previously discussed, comprises a global network of networks and computers, public and private communicating using common protocols. The Internet 88 is the preferable connection method by content page viewers 22, 33, 44 and nnn and content page system 10 in preferred embodiments of the present invention. System end, content page end and viewer end systems can have similar hardware components.

Referring to FIG. 2, the system-end computer 50 is shown. The computer system 50, in a preferred embodiment, comprises a system-side server 51 having one or more databases, including without limitation, a content page/content page rendering area database 60, and can optionally include a tracking server 52 and one or more content file servers 53. The system-side server 51, one or more content file servers 53 and tracking server 52 preferably run in a variety of operating system environments, including MS Windows NT/2000/2003, Unix/Linux and others, and preferably utilize a variety of database management systems, including MS SQL Server, Oracle, MySQL, PostgreSQL and others. The system end computer's server 51 or other operating system has the system custom software application installed thereon.

Connectivity between the system user-end, content publisher site end, the system-end and content viewer-end may be effected in various forms without violating the scope and spirit of the present invention. In particular, network connectivity may be made by a telephone line/modem combination as is well known in the art, a dedicated ISDN line or a cable modem-type set-top-box which provides for Internet connectivity through certain forms of cable television services. Wireless or satellite-based communication can also be utilized. In each of the aforementioned cases, the computer of the website user-end portion will need to be provided with a suitable I/O card, such as a modem, ISDN card, and the like, in order to effect an appropriate interface with the network connection.

The system includes a graphical user interface for system users, typically content page administrators, to create a system account, register the content page and the area of the content page where content is to be rendered and the area of the content page that will cause rendering to be triggered when such area is within the viewer's browser window dimensions and scrolling position, and provide demographic and other pertinent information regarding the content page and information pertaining to the content file(s) to be rendered in the designated page area. The content page triggering area and the content page rendering area can be the same or different areas of the content page. The information is stored as a record in the system server-side database, and the system generates a single tag and link, preferably a JavaScript tag, with the link linking to the system server-side software application, to be placed by the content administrator at the content page where the specified content is to be rendered (although the positioning of the tag/link can be anywhere on the content page, not necessarily in the location of the page where the content is to be rendered). When the content page where the JavaScript tag and link is written/embedded is requested by a viewer via the viewer's browser, the link to the system server-side application is activated and the system server-side application retrieves the corresponding record stored in the system database for the content page and retrieves viewer and browser data from the page request itself. The system server-side software application then generates the custom correlator code. This correlator code assigns a unique ID to the particular viewer/browser and generates HTML code to be used as a marker for the content page area where the designated content will be rendered. The correlator code also generates a query string link that includes the data collected via the correlator code and stores the query string link as a variable on the content page. The correlator code includes the variables and functions to execute the browser window/content page area correlating, based on the positional coordinates of said content page triggering area and the positional coordinates of said viewer's browser window dimensions and scrolling position. When the correlator code determines that the designated content page triggering area is within (or within a pre-defined distance outside of) the dimensions and scrolling position of the viewer's browser window, the query string link stored as a variable on the content page is activated and a JavaScript tag is created that can execute any number of actions, including, but not limited to, generating JavaScript functions to initiate actions and HTML tags to request content such as a link to a content server to retrieve the data and content files for the content page and retrieve and render the designated content in the designated content page rendering area.

In a preferred embodiment, during the registration process the content page administrator enters information related to the content page such as name of page, content data, the specific area of the content page that will trigger content rendering when it is partially or completely within, or within a pre-defined distance outside of, the viewer's browser window dimensions and scrolling position, the specific area of the content page where the content will be rendered (which can be the same as or different from the content page triggering area), and demographic and other information pertaining to the content page. The system then saves this data as a record in the system server relational database, and assigns the record an id, which may be encrypted. The system then generates JavaScript code comprising a single tag with the encrypted ID, with a link to the system server-side application, and the content page administrator places this single tag/link on the content page.

When the webpage containing the JavaScript tag is requested by a viewer, the JavaScript tag link that contains an encrypted ID of the stored data record at the system database in its query string triggers the server-side software application. This custom server side software application is preferably housed in the system server and can be written in C#, PHP or any other appropriate programming language. When the tag/link is a JavaScript tag/link, the server-side application disguises itself as JavaScript in order to respond to the JavaScript tag's request, and collects a variety of information from the request such as domain/address of the content page, the IP address associated with the viewer, and other information from the stored data for the content page, such as information regarding the content file(s) to be rendered, rendering area size, previously entered content page demographics and other information retrieved from the system's relational database.

According to this initial information, as a response, the server side application generates and prints on the content page additional JavaScript code that dynamically creates HTML code on the content page for an HTML layer to be used as a placeholder or marker for the area of the content page where the content is to be rendered and contains all the necessary variables and functions to execute the rendering control and data gathering process described herein from the viewer's browser and the content page, correlating content page rendering area with viewer browser window dimension and scrolling position data. This code also collects additional information available from the viewer's browser such as the viewer's operating system, browser version, as well as a unique browser/user computer id that is assigned to the particular viewer/browser, which can be created by the correlator code itself, or can be created by the system server-side software application and retrieved from cookies or from the system database. The correlator code also gathers the most frequently occurring words in the content page text (for content page indexing), and a list of other content that was already rendered on the page to prevent duplication of the same content on the page and other specific filtering and management for instance while rendering an image in one content rendering it may be preferred to stop loading video in another content rendering—and/or custom information previously stored in cookies, and information collected from the content page. A query string link is then created and all collected information is attached. Then this query string which is stored as a variable on the web page. A webpage or other content page may be divided into or otherwise contain any number of pre-defined designated content rendering areas and the system can monitor if any of those pre-defined content rendering areas of the content page are within the dimensions and scrolling position of the viewer's browser window. If any of the pre-defined content rendering areas come within, or within a pre-defined distance outside of, the viewer's browser window dimensions and scrolling position, the query string link that is stored as a variable on the page is activated and the system dynamically prints HTML code and tags inside the HTML marker that was previously created at the pre-defined content page area where the content will be rendered to render the content in the designated area. The content page area/browser dimension and scrolling position correlator code communicates with the system side-server as well as the content page and the browser.

The system in one embodiment can provide for the rendering of content and communication with a remote server or servers to render content and send content activity information in the form of a self-contained file. Preferably, such file is a flash file identified by the .SWF suffix or any comparable code such as, without limitation, .net, .asp or AJAX. The use of the Macromedia/Adobe Flash file is preferred because of the ability to provide, with Action script, instructional code within the .swf file and communicate with the javascript correlator code and because nearly all customer computer systems have been enabled with the Flash player as a result of normal Internet browser configuration. Also, .swf files have become more universal, and able to execute in a variety of devices, including cell phones, PDA's, television and other devices. It is to be understood that under the teachings of the present invention, any type of file that is capable of operation without the initiation of an additional application could be used in place of Flash and the .swf file and use of a .swf file is not a limitation of the present invention. The content rendering module does not perform the function of the correlator code; instead, the correlator code exists and functions as described above and when it detects the correspondence between the pre-defined content page triggering area and the viewer's browser window dimensions and scrolling position, it triggers the loading of the content rendering module, which renders the content instead of triggering content rendering directly. Enhanced viewer activity tracking can be enabled by use of a .swf or other self-contained application described herein that is referred to as a “content rendering module” and is embedded in the content page, when the correlator code determines that the content rendering area is within (or is within a pre-defined distance outside of) the viewer's browser window dimensions and scrolling position, which includes all necessary code to communicate with the correlator code, a content server and the system server or tracking server. The content rendering module then renders content within itself and gathers additional data regarding viewer actions, such as, for example, clicks, videos watched, length of time video is watched, among other data and communicates that data back to the system database or tracking server. When the correlator code determines that the content rendering area is within (or is within a pre-defined distance outside of) the viewer's browser window dimensions and scrolling position, the correlator code dynamically prints HTML code and tags inside the layer-placeholder that embeds the content rendering module at the rendering area on the content display page. The request for this module contains the previously stored query string with unique id of the module (described above) and the information collected from the system server, viewer's browser and website page (described above) so all of this information is effectively passed to the module. The content rendering module, according to the information in the query string, then renders content from one or more content servers within itself. The correlator code described above communicates with the browser and web page to correlate the coordinates for the pre-defined content page triggering area of the web page within the viewer's browser window dimensions and scrolling position and communicates the information to the content rendering module. The messages can be sent to the content rendering module continually in pre-defined increments, such as every second, or fraction of a second, essentially communicating to the content rendering module how many seconds the area of the webpage is available in a viewer's browser window. In addition, the content rendering module itself collects information related to the content rendered, including, but not limited to, clicks, videos watched, and other data. The content rendering module then sends the information it is collecting to the system server at pre-defined intervals (information can be sent immediately, or collected and sent). All of this information can be sent from the content rendering module to the system server or tracking server(s) using file server direct communication or FSDC technology. Tracking information can be sent to a tracking server for storage and retrieval by system users. FSDC is a method to establish a direct connection between a self-contained self-executing file and a custom network server-based application. FSDC preferably uses a .swf file or alternately an HTML or AJAX file which sends a query string directly to a specific URL or a desired network server without loading a variable from the file or requests to the history object of a viewer's network browser, as more fully described in U.S. Pat. No. 7,313,590, which is incorporated by reference herein. The files include instructional coding that allows the file to establish a direct connection with one or more servers, including servers storing content files that can then be run, and servers that when contacted track the access and use of the content files. In one embodiment, content rendered via such a content rendering module can communicate, via the content rendering module, with the web page area/browser window dimensions and scrolling position correlator code with useful effect; for example, a video may be part of the advertisement rendered at the designated content page area via the content rendering module and upon viewer's click on an optional video preview button the same correlator code creates another dynamic layer above all the existing layers on the web page that covers a certain portion of the viewable area of the browser window to show content/video above the content of the page. The same content page area/browser dimension and scrolling position correlator code tracks how many times content was rendered at a particular rendering area and how many other rendering areas are designated on a content page but are not in view because the area on the content page where such rendering area is located was not within, or not within a pre-defined distance outside of, the dimensions and scrolling position of the viewer's browser window or did not completely render for a certain period of time. The same web page area/browser window dimensions and scrolling position correlator code can also keep track of content rendering module Id's to prevent duplication of content on the same page. The same correlator code also may store the collected and or custom information in cookies using the website domain for the page where the content rendering area is located and may request it later and send this information, when needed, to the domain of the system server for tracking and reporting. This feature is optional and designed to optimize the process, for if information previously gathered in cookies can be saved and retrieved when a viewer returns to the web page there is no processing unnecessarily repeated by the system. It is important to note here that if optional cookies are utilized by the system, they are saved by the content page/website itself, and consequently attributed to the content page/website's domain, not the content rendering module system server domain, so the cookies are not considered “third party” or data mining cookies that are typically flagged or blocked by web security applications. When a viewer leaves or closes the content page the correlator code indicates to all the content rendering modules that are then loaded how much time, if any, that their content has been rendered and sends this information to the dispatcher server using FSDC. The record that is already stored is updated.

The correlator code described above periodically checks the location of the content rendering area location (the HTML layer marker on the content page). The portion of the designated content triggering area that needs to fall within the browser window dimensions and scrolling position in order to initiate content rendering can be varied, and may be customized by the system administrator. For example, the system may send a message that the content is available when 90% of the designated content page triggering area is within the viewer's browser window dimensions and scrolling position, or is within a specified distance from the viewer's browser window dimensions and scrolling position. The area/browser dimension and scrolling position correlator code at the content page can send these messages to a content rendering module or server side application continually in pre-defined increments, such as, for example, every second, or fraction of a second, communicating to the dimensions and scrolling position of the viewer's browser. The content rendering module then sends the information it is collecting from the content rendering area/browser dimension and scrolling position correlator code to the content rendering module database, which is preferably housed in the server for tracking at pre-defined intervals (information can be sent immediately, or it can be collected and sent periodically.)

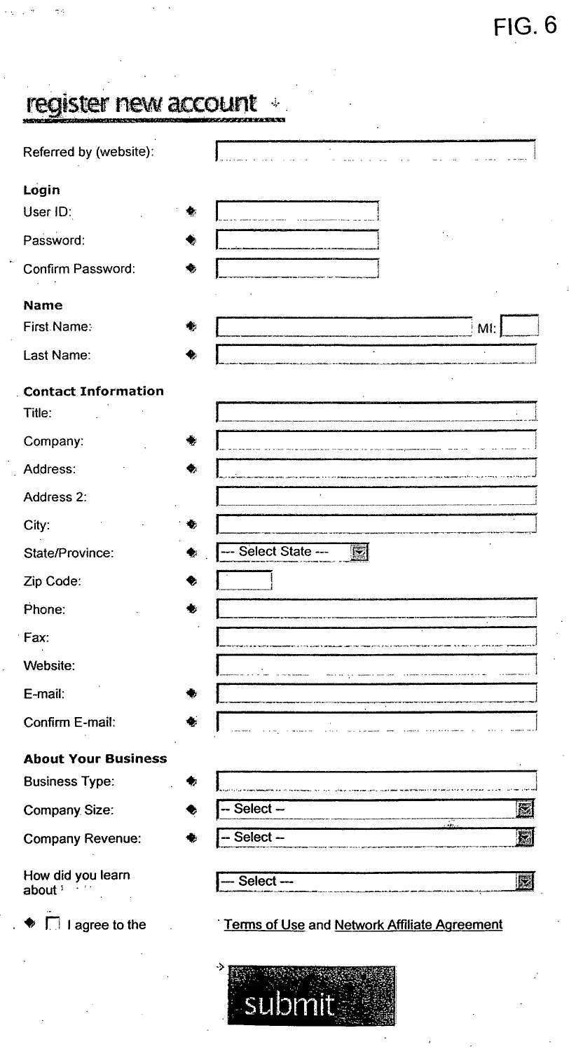

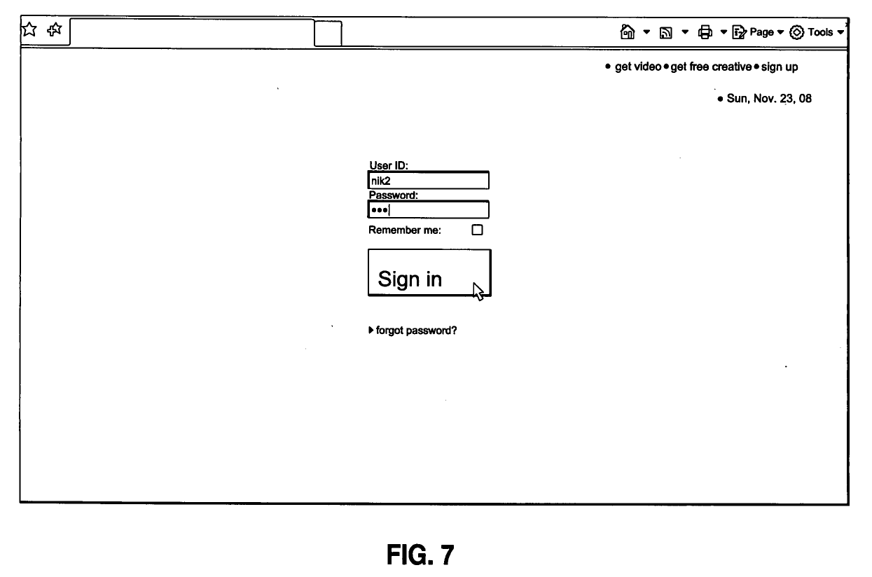

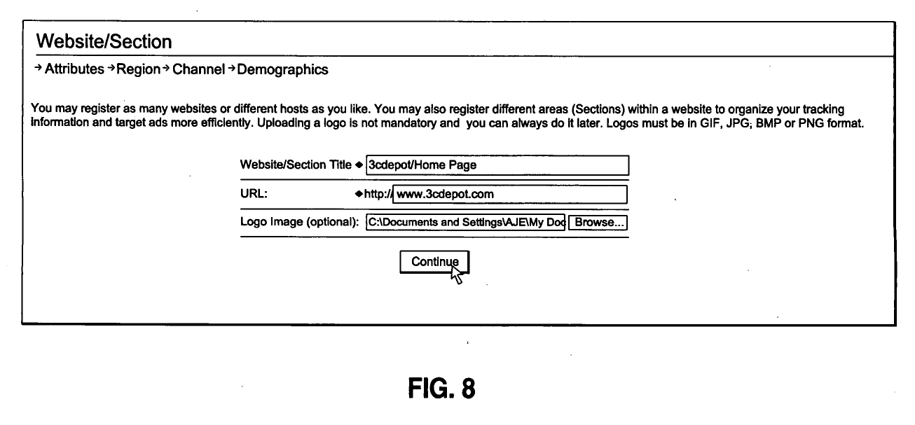

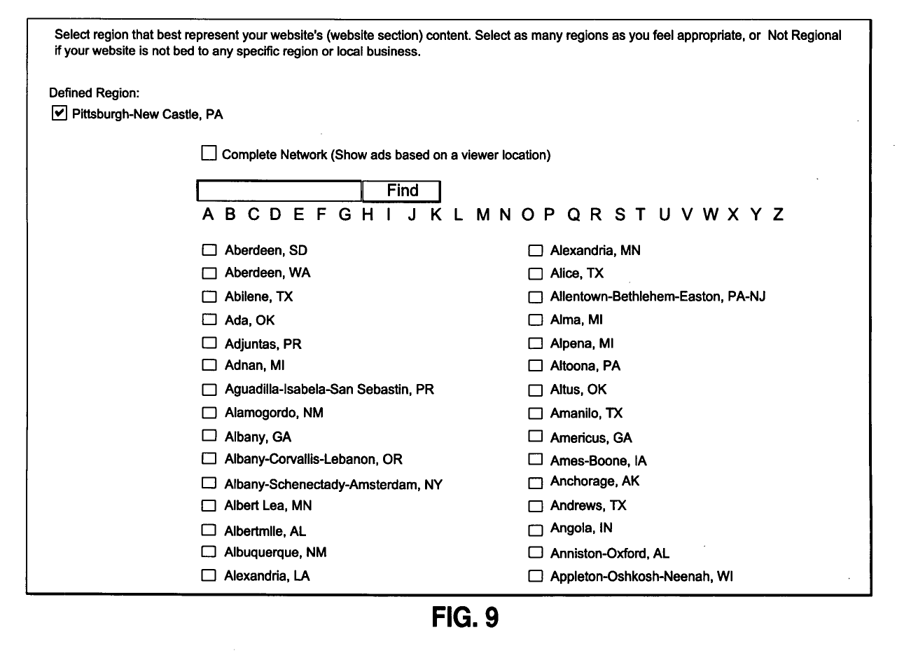

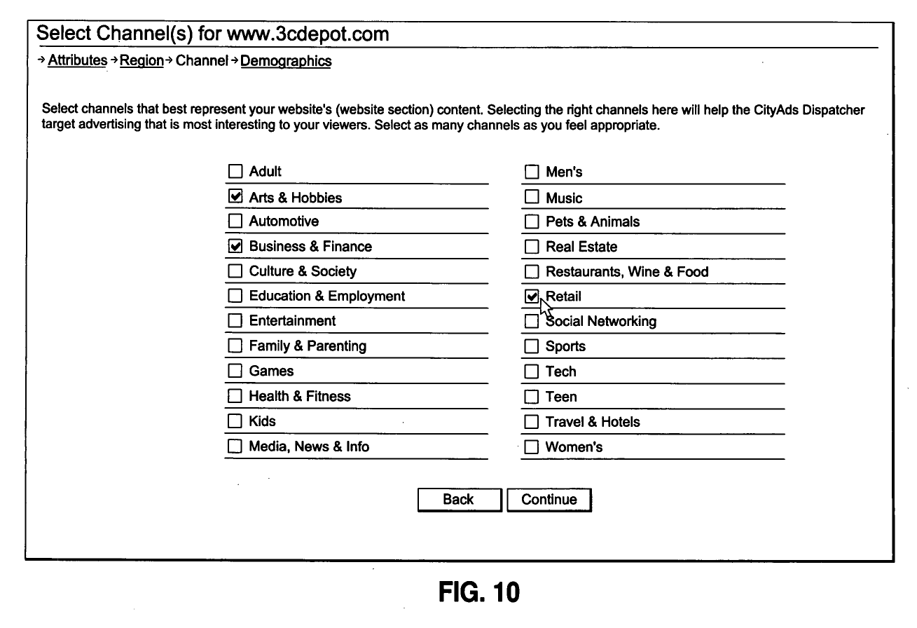

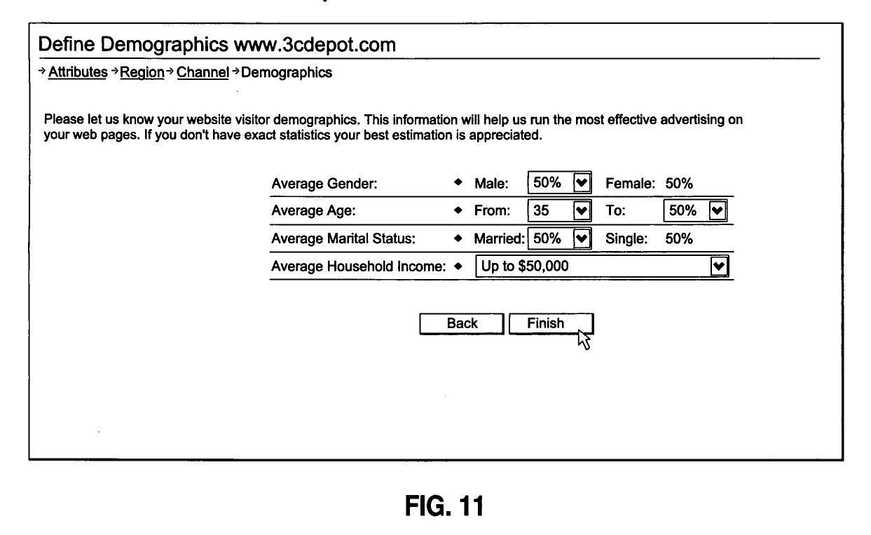

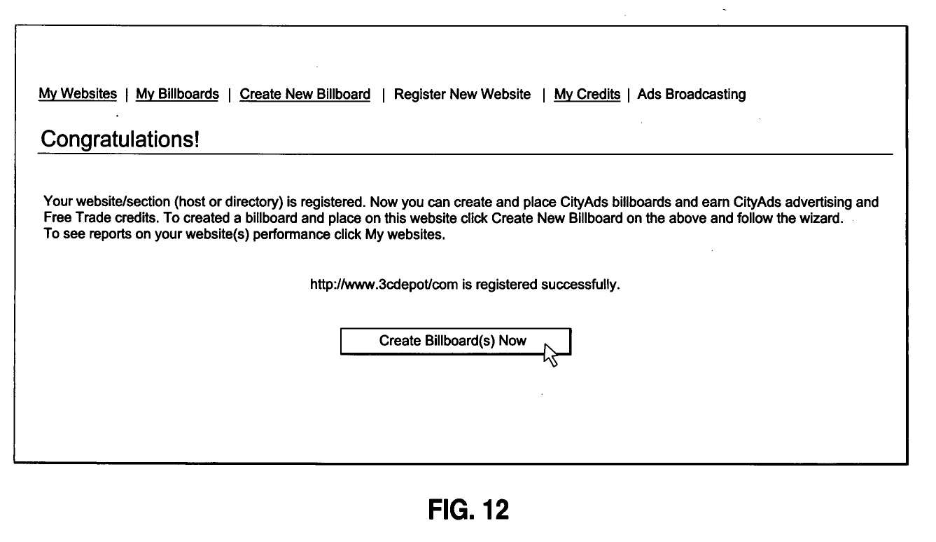

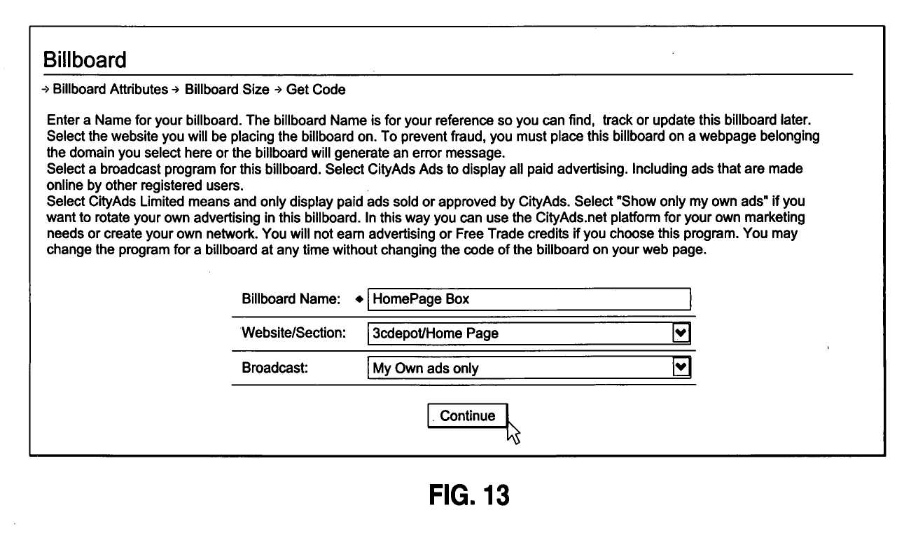

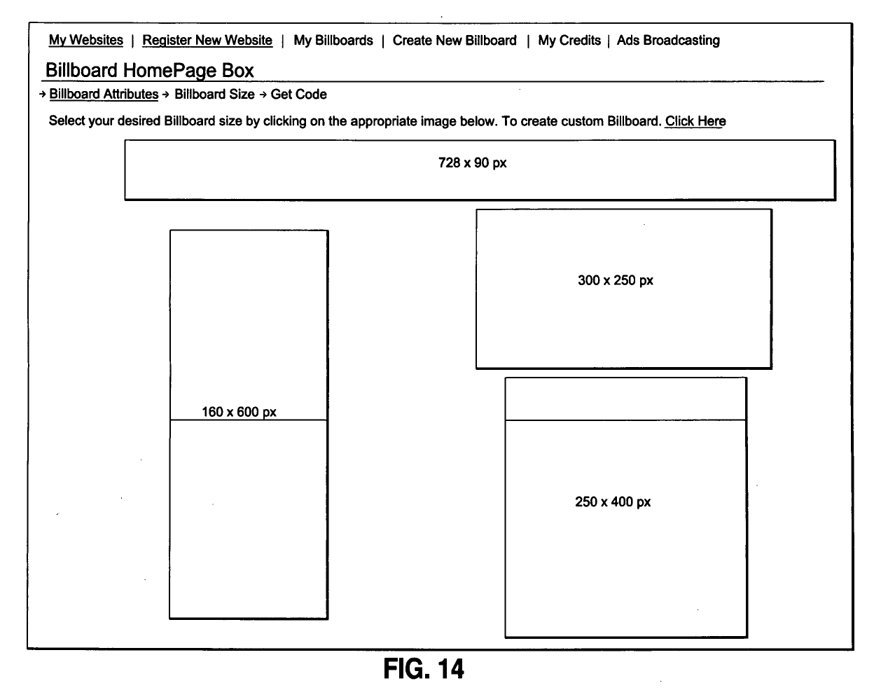

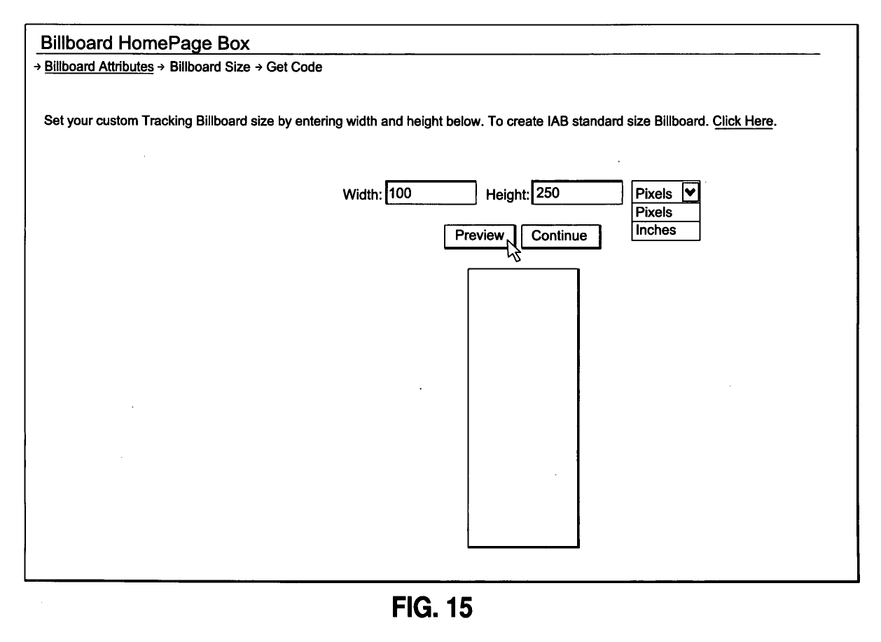

The system is preferably made available to website operators via a system website for use by them after registering as a website content administrator. Referring to FIGS. 4-A, 4-B and 4-C, which shows the process flow of the method implemented with the system of the present invention, as shown in FIG. 4-A, a content page administrator accesses the system, which is preferably accessible via the Internet as a website, and is presented with the system graphical user interface screens, beginning with a registration screen. FIG. 6 depicts a sample system content site administrator user registration screen whereby a content page administrator can register with the system. FIG. 7 depicts a sample system login screen. As shown in FIG. 4-A, content page administrators first register with the system 100 as a content display site administrator and enter data pertaining to the content page, the content page triggering area that will trigger content rendering when it is within, or within a pre-defined distance outside of, the viewer's browser window dimensions and scrolling position, the area of the content page where the designated content will be rendered (which may be the same area as the area of the content page that will trigger rendering of such content when such area is within, or within a pre-defined distance outside of, the viewer's browser window dimensions and scrolling position), as well as designating the content to be rendered in a particular area of the content page, content page demographics and other pertinent information 200. The system user interface screens provide means for receiving from content page administrators the content page address, content file information (which may be in the form of instructions to retrieve one or more content files stored in a content server or storage device), content display area parameters and other content page data from content page administrators and system server with a database for storing one or more records containing such data, each record being given an identification code. FIG. 8 depicts a sample system user registration screen showing data entry relating to content page title, uniform resource locator address and optional logo image. FIG. 9 depicts a sample user registration screen whereby content page administrators enter their content page's primary audience geographic location. Content page administrators can select the geographic region that represents the location of the content page's primary audience, if any. FIG. 10 depicts a sample user registration screen whereby content page administrators enter their content page's content type. FIG. 11 depicts a sample user registration screen whereby content page administrators enter their content page audience demographic data. FIG. 12 depicts a sample content page registration confirmation screen. FIG. 13 depicts a sample content page rendering area creation screen. Content page administrators can designate a content page rendering area for a content page by entering a name for the content page rendering area, selecting a previously registered content page, and designating content distribution parameters. FIG. 14 depicts a sample content page rendering area dimension selection screen, whereby content page administrators can select one or more pre-set content page rendering area dimensions. FIG. 15 depicts a sample content page rendering area dimension specification screen where content page administrators can enter customized content page rendering area dimensions and position parameters.

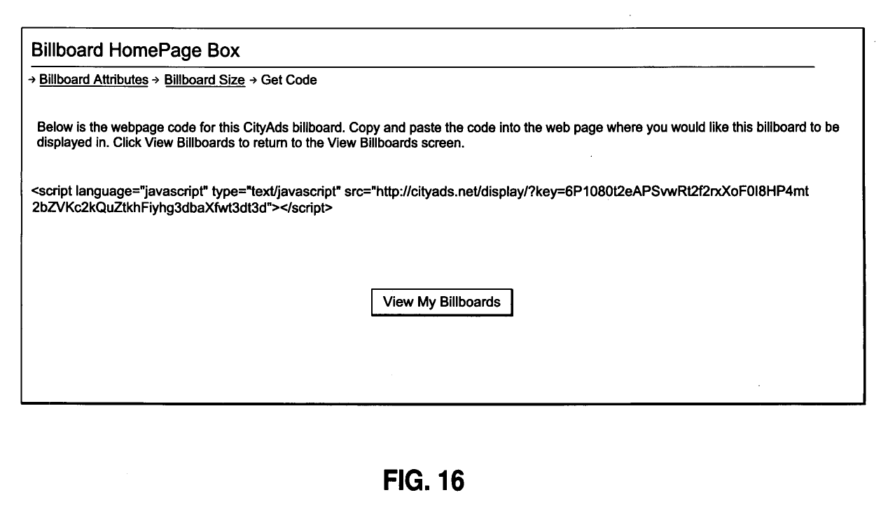

Referring to FIG. 4-A, the above-referenced data is then saved by the system as a data record in the system database and an identification code is assigned to the data record 300, as shown in FIG. 15. The system software applications then generate a JavaScript tag with the link to the system server-side application including the ID of the record stored in the system database pertaining to the particular content page, content rendering area and content 400, and the content page administrator places the JavaScript tag and link on the content page 500. The tag includes the identification code for the corresponding record stored in the system database and a link to a system server-side application. FIG. 16 depicts a sample screen wherein a JavaScript tag with link to the system server-side application is generated for content page administrators to copy and paste into the page code of the content page in which the designated content page rendering area resides.

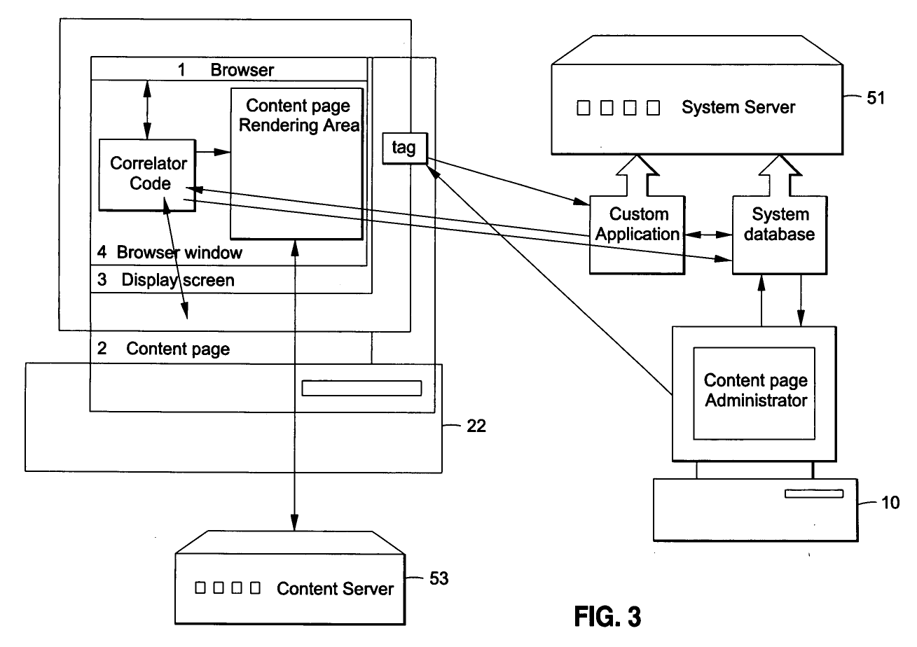

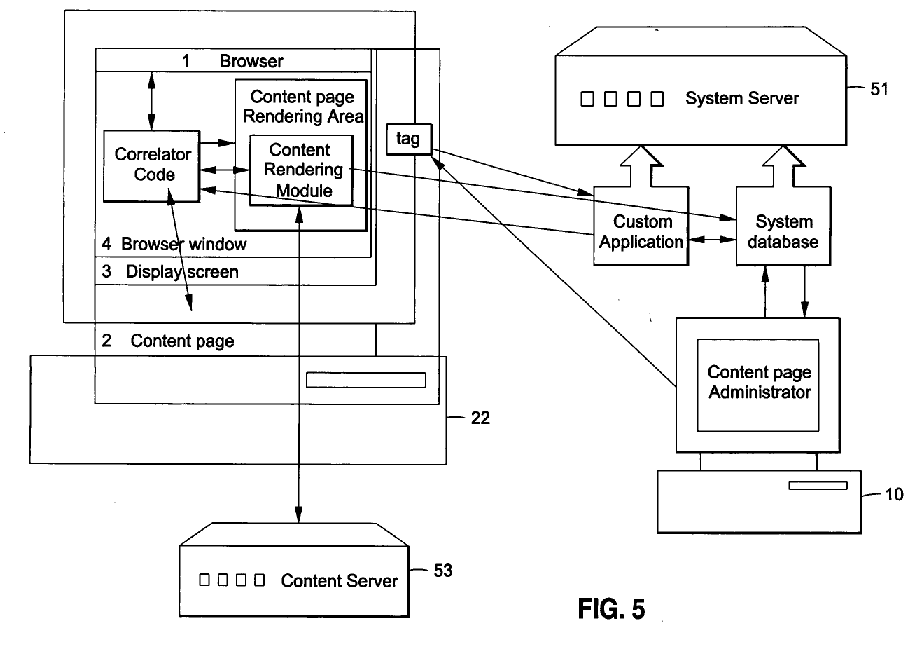

As shown in FIG. 4-B, when a content page viewer requests the content page that has such JavaScript tag and link 600, the request activates the link to the system server-side application and the system application collects a variety of information from the viewer's HTTP request, including, but not limited to, the address of the content page and the viewer's network address (for example, the Internet Protocol address associated with the viewer when the network is the Internet) 700, and retrieves the corresponding data record stored in the system server database, and generates code, preferably JavaScript code, referred to as a “correlator code,” which is written to or otherwise embedded on the content page. This correlator code then dynamically generates HTML code on the content page for a layer to be used as a marker for the content page area where the content will be rendered 800. The correlator code can be positioned anywhere on the content page, not necessarily the location on the content page where the particular content will be rendered. A unique identification code is then assigned to the particular viewer/browser which can be created by the correlator code itself, or can be created by the system server-side software application and be retrieved from cookies or from the system database. The correlator code collects additional information from the viewer's browser, including, without limitation, the viewer's operating system and browser type/version, the most frequently occurring words in the web page text, and a list of other content that was already rendered on the page to prevent duplication of the same content on the content page, among other data 900. The correlator code application then generates a query string link including the data collected via the correlator code and the query string link is stored as a variable on the content page 1000. The correlator code periodically checks viewer browser screen coordinate data from the viewer's browser application with content page coordinates for the content page triggering area. FIG. 3 provides a diagrammatical representation of the communication flow between system components, content page administrators and content page viewers, and FIG. 5 provides a diagrammatical representation of the communication flow between system components, content page administrators and content page viewers in an embodiment that includes a content rendering module. The various arrows indicate the flow of communication between system components as the system operates, as explained below. As a viewer scrolls through a content page (whether up and down or left and right) or the viewer's browser window dimensions change, the correlator code periodically checks the viewer's browser window scrolling position and dimensional coordinates and when there is correspondence (either partial or full, as has been designated or programmed into the system) between the browser window coordinates and the coordinates for the pre-defined content page triggering area (or between coordinates that are a pre-defined distance outside of the viewer's browser window dimensional and scrolling position coordinates) 1100, the query string link is activated, the correlator code dynamically generates HTML code and tags inside the previously generated HTML marker where the content will be rendered 1200 and the content is rendered in the designated content page rendering area 1300. The correlator code also records at the content page data retrieved from the viewer's browser regarding the rendering of the content, including, but not limited to the IP address associated with the viewer, browser and operating system version, unique identifier assigned by the server side application and information related to the text on the web page. The communication flow between system components is indicated in FIG. 3 by the arrows: Content page administrator 10 registers content page data with the system server 51 and the information is stored as a data record in the system database which resides in the system server, with a tag/link sent back from the system to the content page administrator 10 (as indicated by the arrows between content page administrator 10 and system database), who then places such tag/link on the content page (as indicated by the arrow from content page administrator 10 to the content page 2 at “tag”). When a viewer requests the content page 2, the tag links to the custom application (as indicated by the arrow from tag to custom application), the custom application retrieves data from the database (as indicated by the arrows between custom application and system database). The custom application then generates the correlator code and it is written to or otherwise embedded on the content page (as indicated by the arrow from the custom application to the correlator code box in the content page 2). The correlator code communicates with the content page 2 and with browser 1 as indicated by the arrows between said elements and also dynamically generates the HTML layer that serves as a marker for the content page rendering area (as indicated by the arrow between the correlator code and the content page rendering area boxes). When the correlator code determines that the content page triggering area, which, in the case of FIG. 3, is the content page rendering area, the query string link that is stored as a variable on the content page is activated and the correlator code dynamically generates HTML code and tags inside the HTML marker and the content is retrieved from content server 53 and the content is rendered in the content page rendering area (as indicated by the arrows between the content page rendering area and the content server). The correlator code communicates directly back to the system database with data retrieved from the browser and content page (as indicated by the arrow from the correlator code back to the system database).

FIG. 4-C is a process flow diagram showing steps of the method of the present invention in a preferred embodiment that utilizes a “content rendering module.” When the designated content page triggering area (which may be the same as the content page rendering area) is determined to be within the viewer's browser window dimensions and scrolling position, the content rendering module is requested. The correlator code in this embodiment dynamically prints HTML code and tags inside the layer/marker that retrieves from a remote server, system server or the content server, and embeds a .swf file referred to as a “content rendering module” The “content rendering module” is preferably a .swf file or any comparable code such as .net .asp, AJAX or other form that contains all the necessary code to communicate with the correlator code on the webpage, retrieve and render content from a remote content server and send and retrieve data and variables from a remote server or servers. The request contains the previously stored query string with unique ID of the content rendering area stored in a remote server and the information previously collected by the system database and correlator code 1200 (all of which is passed to the module). When the content rendering module set inside the content page rendering area is loaded and initiated it establishes communication with the correlator code on the content page where it is embedded as well as the system server or any remote server with the appropriate network protocol, 1300. The content rendering module then sends a request to the content server where the designated content files are located or to a database where a command and parameter file is stored with commands and parameters to retrieve, assemble and load the designated content files, and the content is rendered within the module area 1400. The content rendering module then checks if all of the elements of the content are loaded and rendered and communicates that this is so to the correlator code 1500. The correlator code continues to monitor the location of the content page rendering area and once it receives a signal from the content rendering module that the content is loaded and rendered it communicates back to the content rendering module whether it is within the viewer's browser window dimensions and scrolling position or not 1600. The content rendering module then sends information it is collecting via the correlator code to a system database, residing in the system server for reporting, preferably using FSDC 1700. The communication flow between system components is indicated in FIG. 5 by the arrows: Content page administrator 10 registers content page data with the system server 51 and the information is stored as a data record in the system database which resides in the system server, with a tag/link sent back from the system to the content page administrator 10 (as indicated by the arrows between content page administrator 10 and system database), who then places such tag/link on the content page (as indicated by the arrow from content page administrator 10 to the content page 2 at “tag”). When a viewer requests the content page 2, the tag links to the custom application (as indicated by the arrow from tag to custom application), the custom application retrieves data from the database (as indicated by the arrows between custom application and system database). The custom application then generates the correlator code and it is written to or otherwise embedded on the content page (as indicated by the arrow from the custom application to the correlator code box in the content page 2). The correlator code communicates with the content page 2 and with browser 1 as indicated by the arrows between said elements and also dynamically generates the HTML layer that serves as a marker for the content page rendering area (as indicated by the arrow between the correlator code and the content page rendering area and content rendering module boxes). When the correlator code determines that the content page triggering area, which, in the case of FIG. 5, is the content page rendering area, the query string link that is stored as a variable on the content page is activated and the correlator code dynamically generates HTML code and tags inside the HTML marker and the “content rendering module” is retrieved from a remote server 53. The content rendering module when initiated establishes communication with the correlator code on the webpage and the system database residing on the system server then requests, loads and renders content from a remote content server and the content is rendered in the content page rendering area (as indicated by the arrows between the content page rendering area and the content server). The correlator code communicates in this embodiment directly back to the content rendering module rather than directly to the system database, with the content rendering module then communicating back to the system database, with data forwarded by the correlator code which was retrieved from the browser and content page (as indicated by the arrows from the correlator code to the content rendering module and from the content rendering module back to the system file).

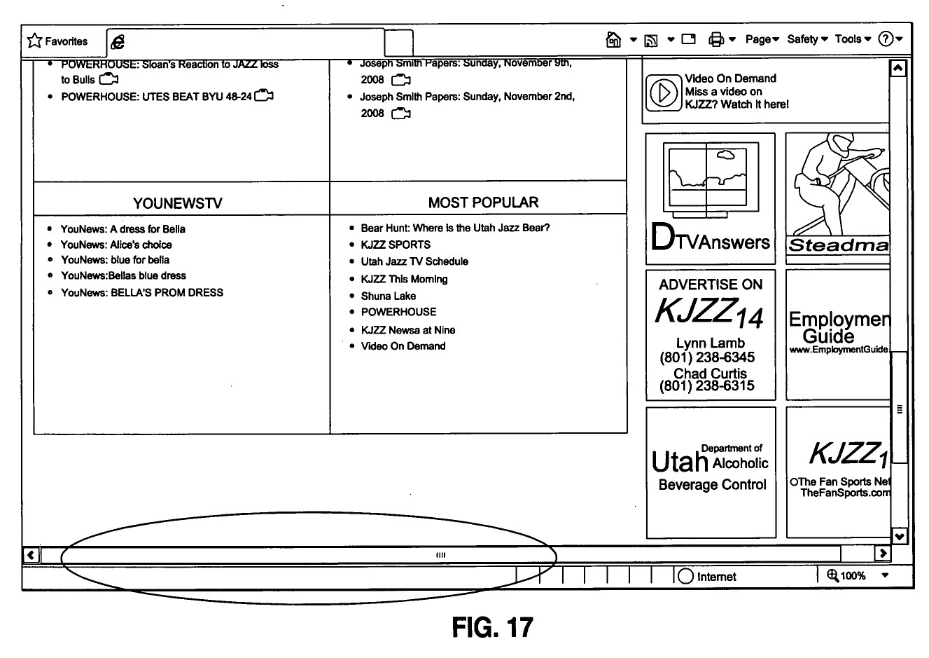

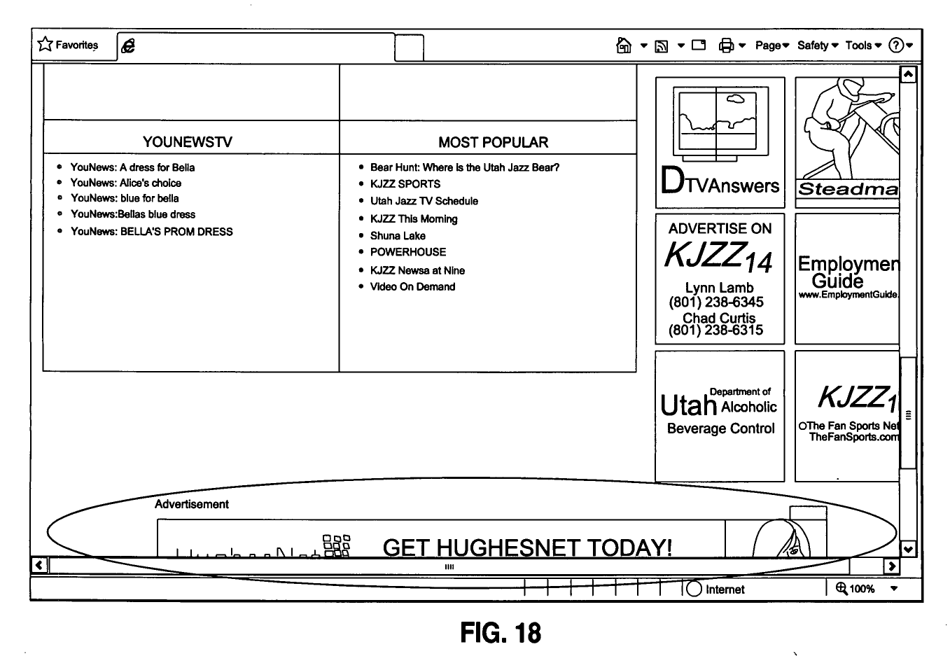

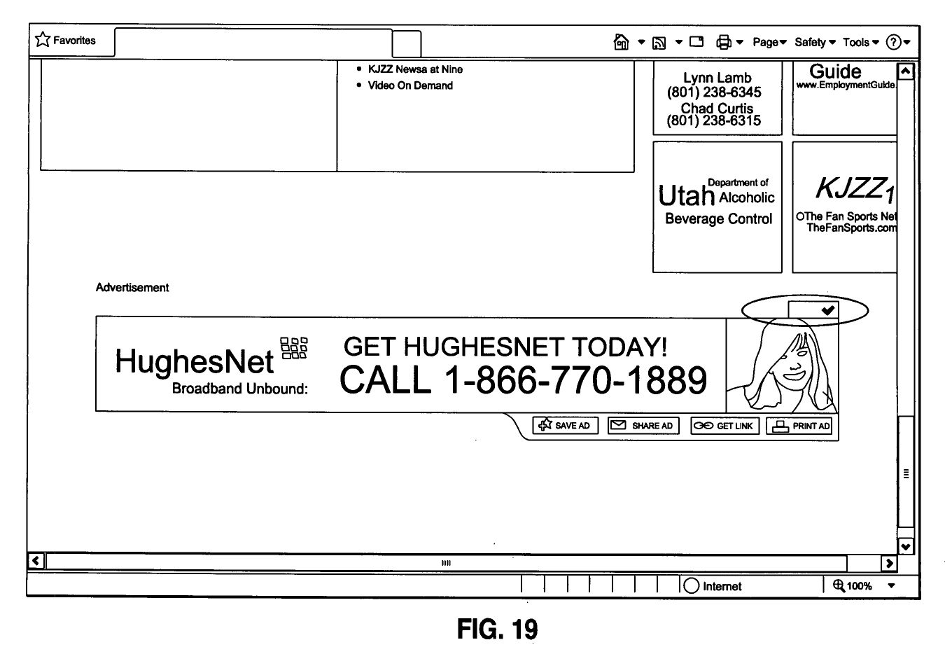

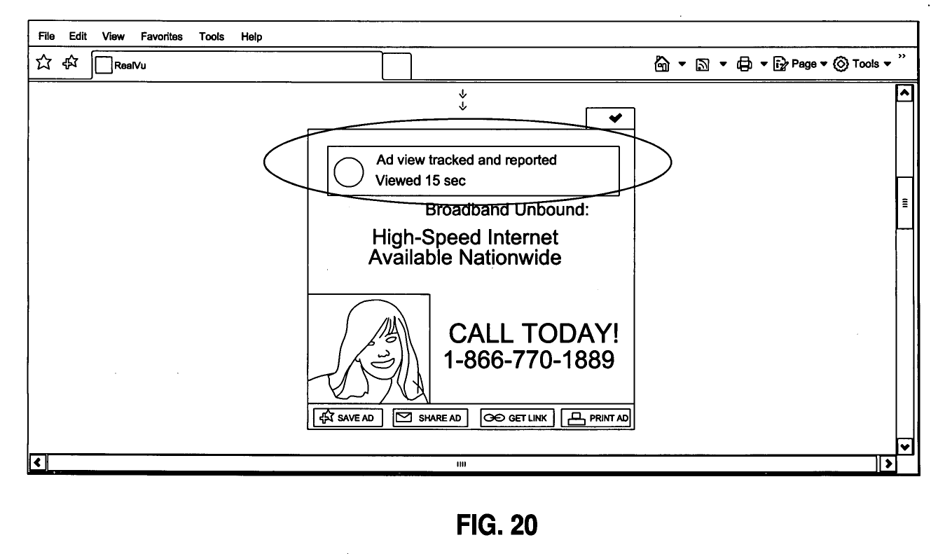

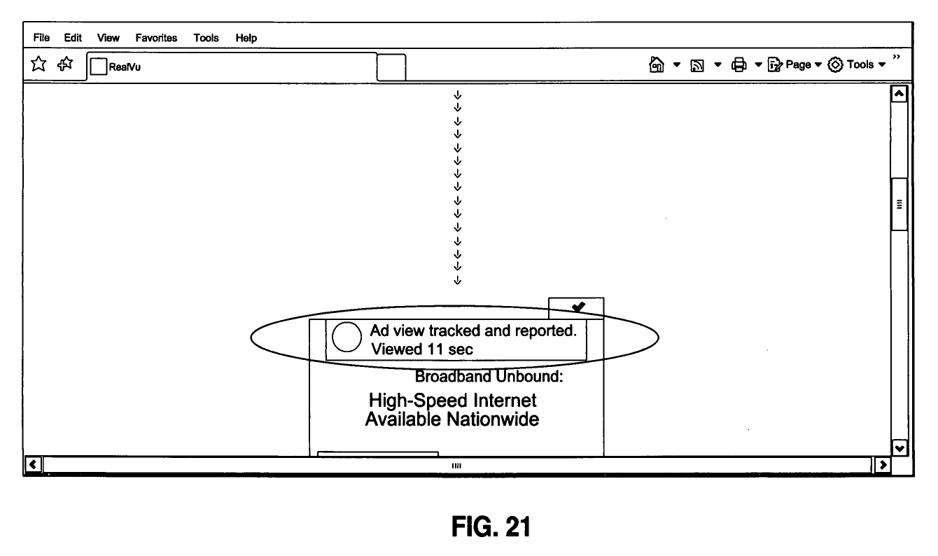

FIG. 17 depicts a sample content page as presented to a content page viewer, with the content rendering area of the content page located below the viewer's browser window dimensions and scrolling position, noted by an oval indicator. Content rendering is not yet triggered because the designated area of the content page that must be within the viewer's browser window dimensions and scrolling position is not yet within such dimensions and scrolling position. FIG. 18 depicts a sample content page with the content rendering area entering the viewer's browser window dimensions and scrolling position. At this point, if content rendering is set to trigger when the designated area of the content page is partially within the viewer's browser window dimensions and scrolling position, the correlator code would proceed to activate content rendering. FIG. 19 depicts a sample content page with the content rendering area fully within the viewer's browser window dimensions and scrolling position. As this point, if content rendering is set to trigger when the designated area of the content page is wholly within the viewer's browser window dimensions and scrolling position, the correlator code would proceed to activate content rendering. FIG. 20 depicts a sample content page with the content rendered and an indicator showing the time that the content has been rendered. FIG. 21 depicts a sample content page with the content rendering area partially outside of the viewer's browser window dimensions and scrolling position. As the designated content page area that has to be either partially or wholly within the viewer's browser window dimensions and scrolling position is no longer within such dimensions and scrolling position, the previously rendered content can be removed from the page and/or be replaced with new content and content related to the content page area that is then within the viewer's browser screen dimensions and scrolling position would be triggered for rendering. The system rendering counter stops counting when the predefined page area is no longer within the viewer's browser window dimensions and scrolling position, and can resume counting if the area returns within the viewer's browser window dimensions and scrolling position.

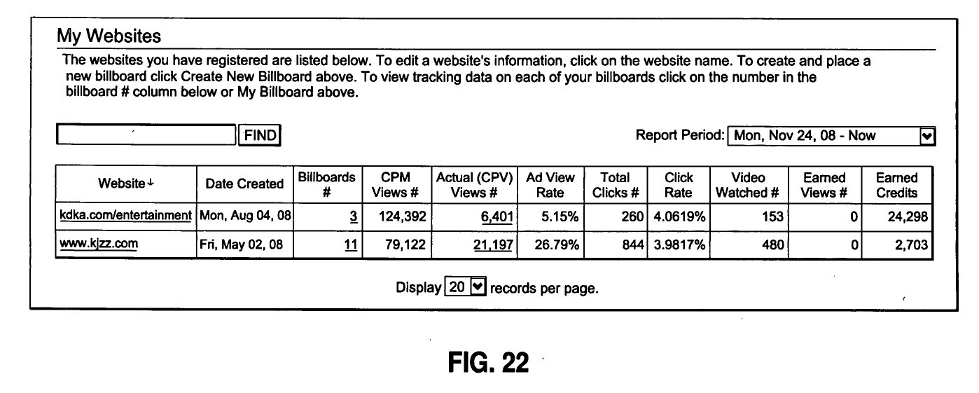

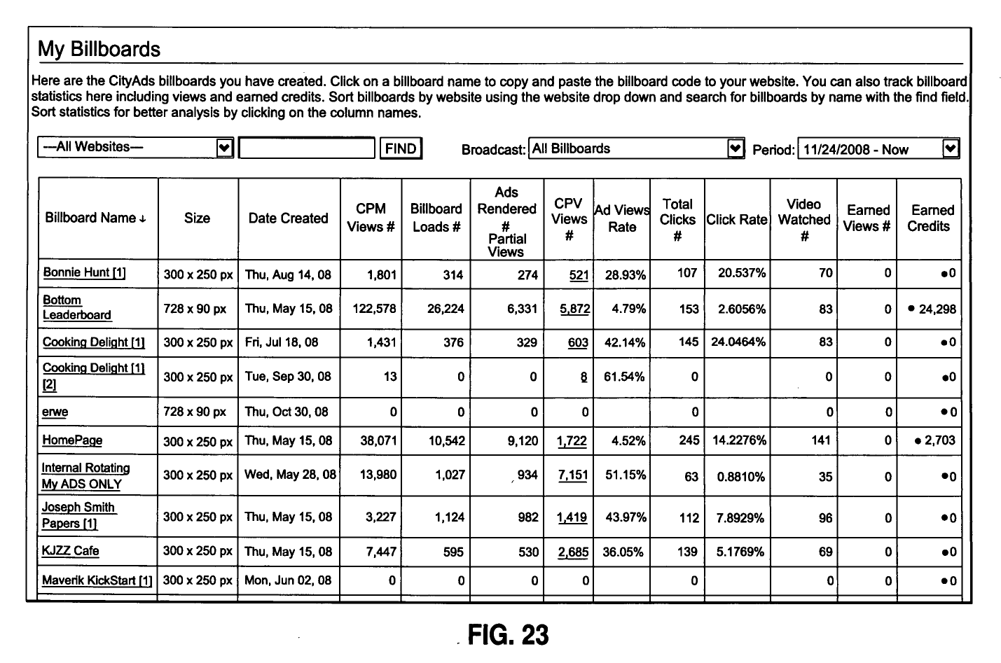

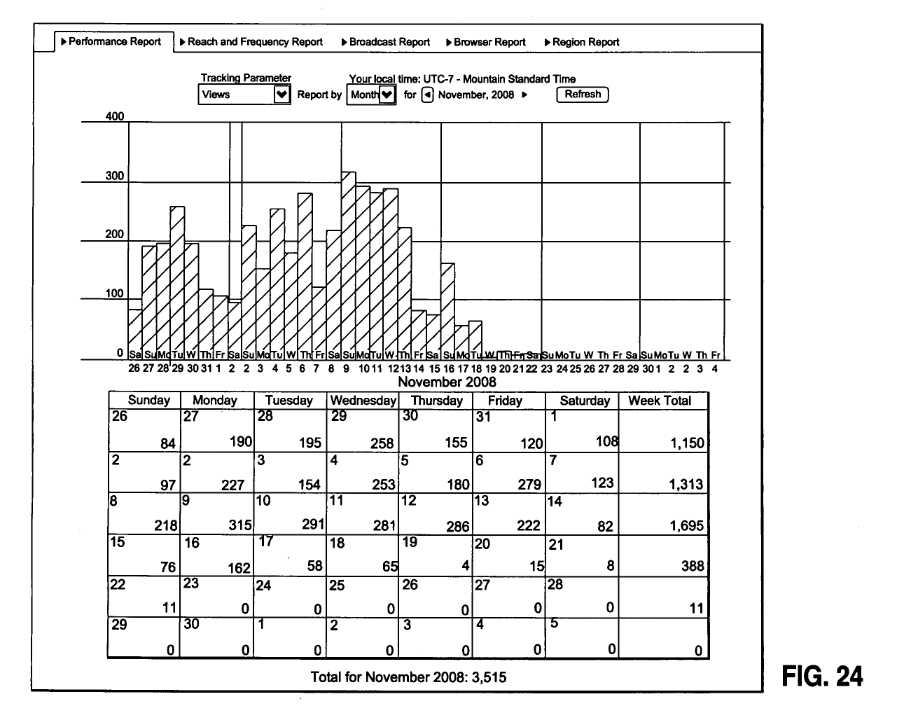

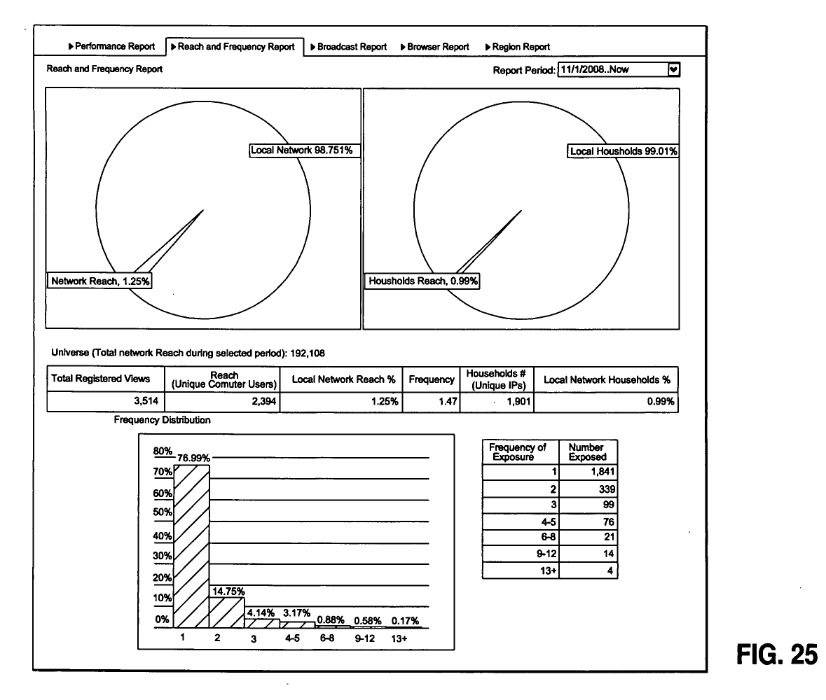

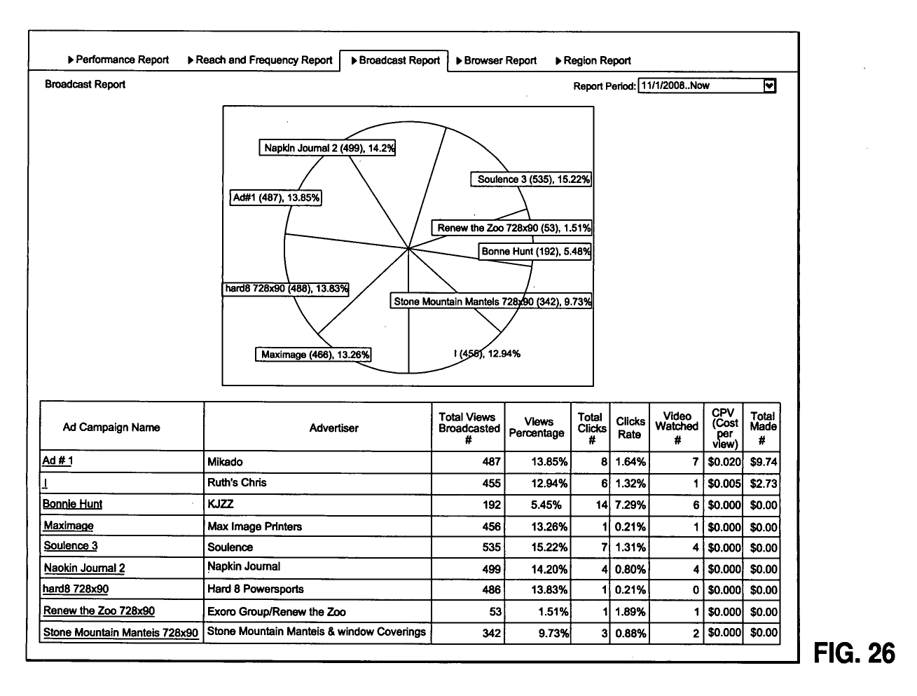

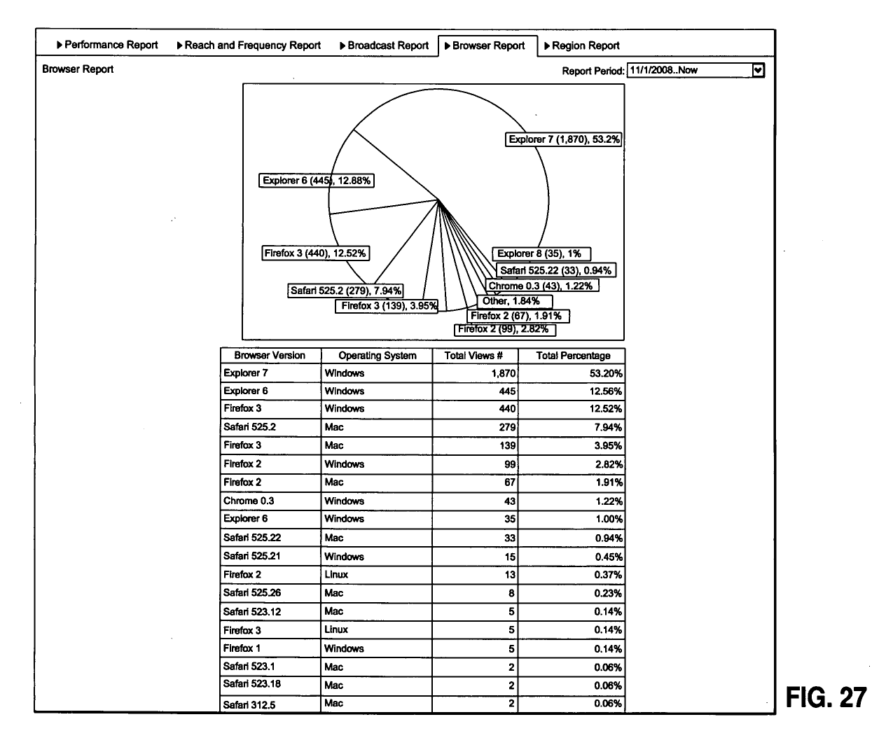

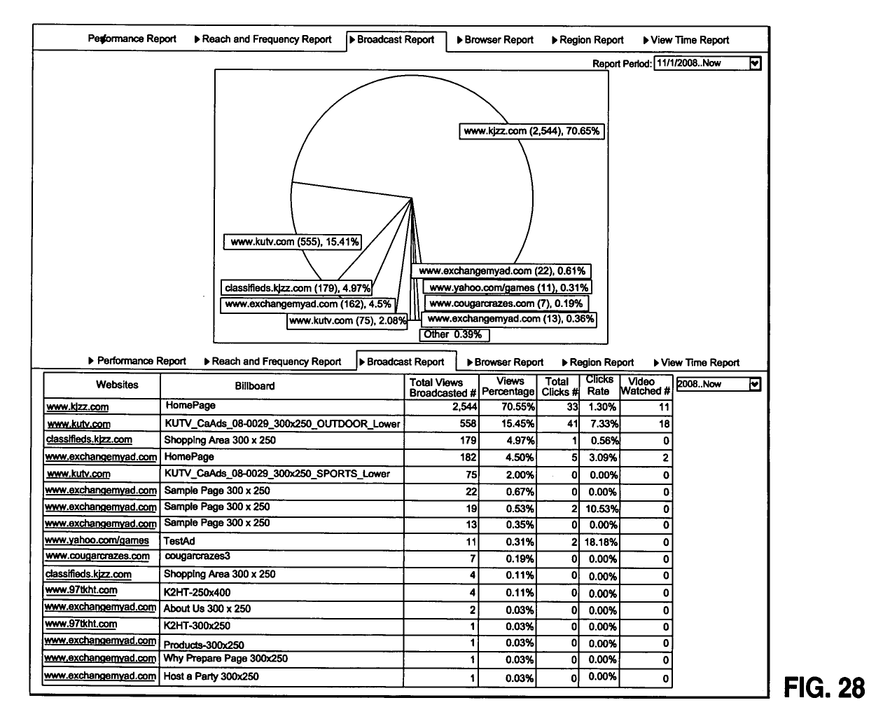

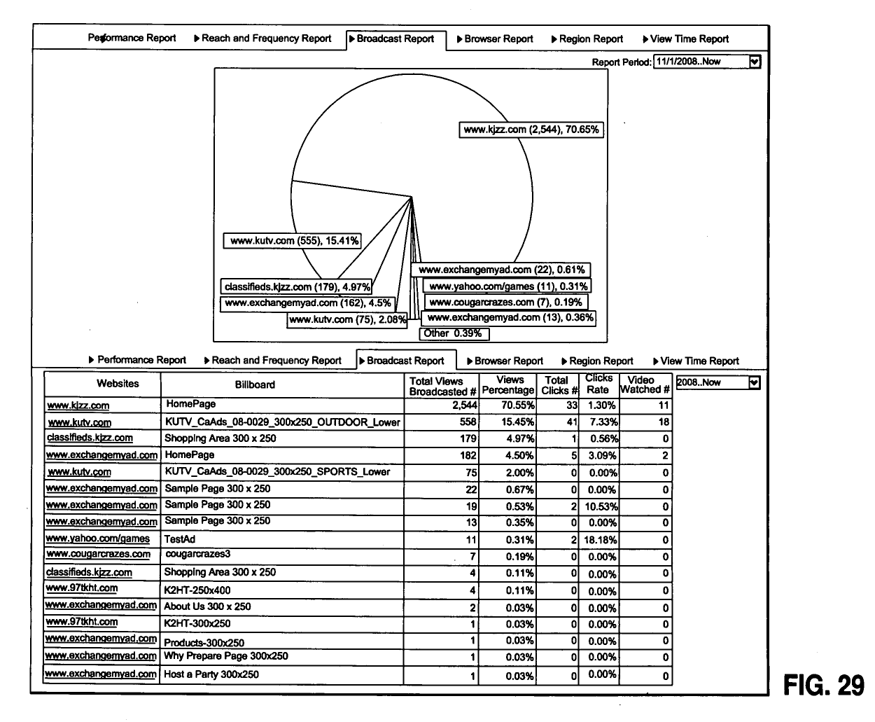

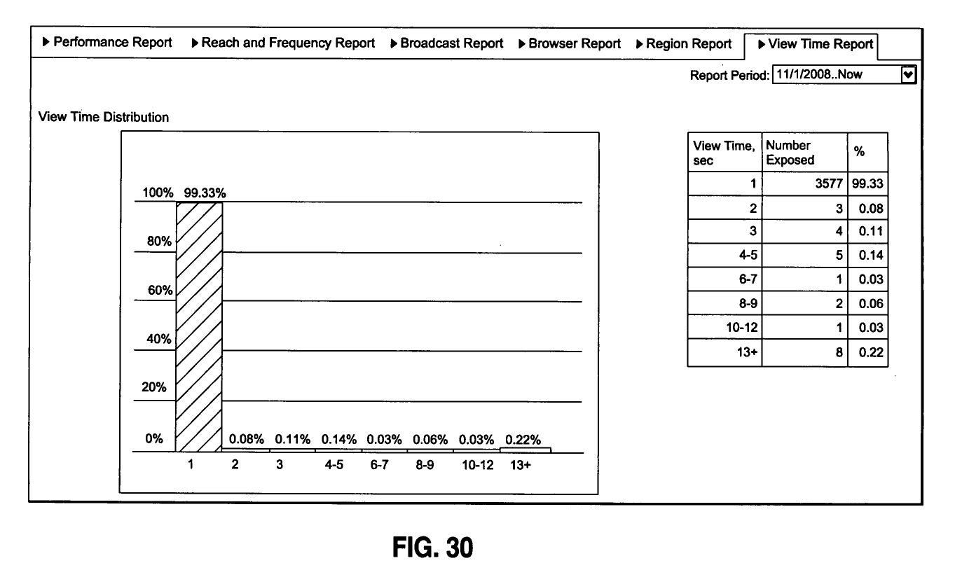

The system users can log onto a password protected system, preferably web-based interface and view detailed reports related to content rendered via the system. Reports may be customized to reflect different time periods and different meta-data. Reporting features for website and other content publishers include, but are not limited to, information for rendering activity in particular website page sections that shows, for example, the number of times content was rendered, the number of times content was within the dimensions and scrolling position of the viewer's browser window, the duration of time that content was within the dimensions and scrolling position of the viewer's browser window, as well as data such as video viewed, video view duration, click to http destination, custom button clicks (such as print coupon, email), number of unique computer browser users each content rendering was available to (reach) and how many times each content rendering was available to each unique computer browser user (frequency), the browser type of each viewer for which the content was rendered, and the general geographic location of each user the content was available to (by ISP) and the percentage of the network users reached by content rendering module content in a region or nationally. Other custom parameters not mentioned here may be reported. Reports may be parsed by all web site sections or one website section/page or otherwise. FIG. 22 depicts a sample system content page data report screen showing the content pages registered, date created, with the content page triggering areas and content page rendering areas that have been designated indicated (see the column titled “billboards#”), and data retrieved such as number of times that the content related to a designated content page rendering area has been requested, number of times that the content related to a designated content page rendering area has been rendered, the percentage of content rendering vs. content request, click-through rate and total number of clicks, and other content rendering activity data. FIG. 23 depicts a sample system content rendering area data report screen showing content rendering activity for specific content page rendering areas of a content page, including the content rendering area dimensions, date created, number of times content page area was requested, number of times the content designated for the particular content page rendering area has been rendered, and other content page rendering area activity data. FIG. 24 depicts a sample system content rendering area activity report screen showing a report and bar graph of data pertaining to content rendered within viewer browser screen dimensions and scrolling position in a given period (a monthly period is indicated in the exemplary report shown in FIG. 24). FIG. 25 depicts a sample system content rendering area data report screen indicating data pertaining to the viewers of rendered content, such as their Internet protocol address, as well as the number of unique viewers and the content's reach and frequency of rendering. FIG. 26 depicts a sample system content rendering activity report screen showing a graph and table of the content rendered, organized by content name, including rendering data for each, which content page administrators can use to assess which content is more often rendered than others. FIG. 27 depicts a sample system viewer browser type data report screen providing information as to the types of browsers being used by viewers to view rendered content. FIG. 28 depicts a sample system viewer geographic location report screen providing information regarding the location of the viewership of the rendered content. FIG. 29 depicts a sample general content rendering area activity report screen providing information regarding the content pages and content page rendering areas within said content pages and their rendering activity. FIG. 30 depicts a sample content rendered time data report screen providing information regarding how long content was rendered within a viewer's browser window dimensions and scrolling position.

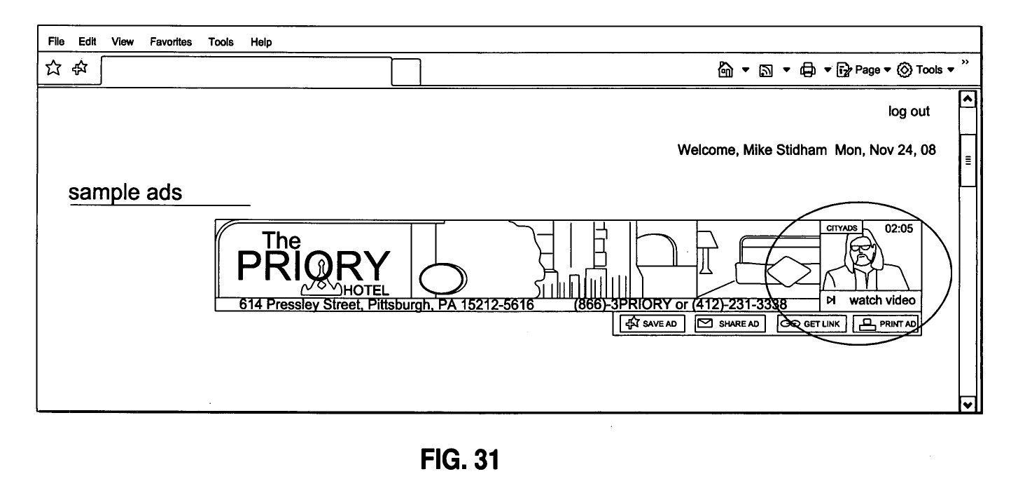

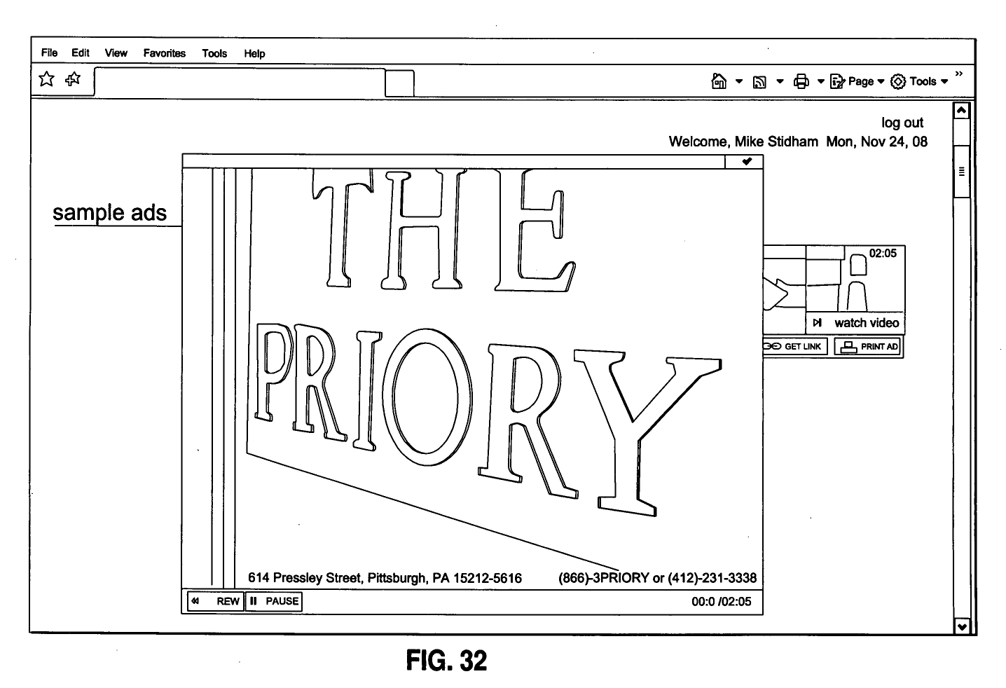

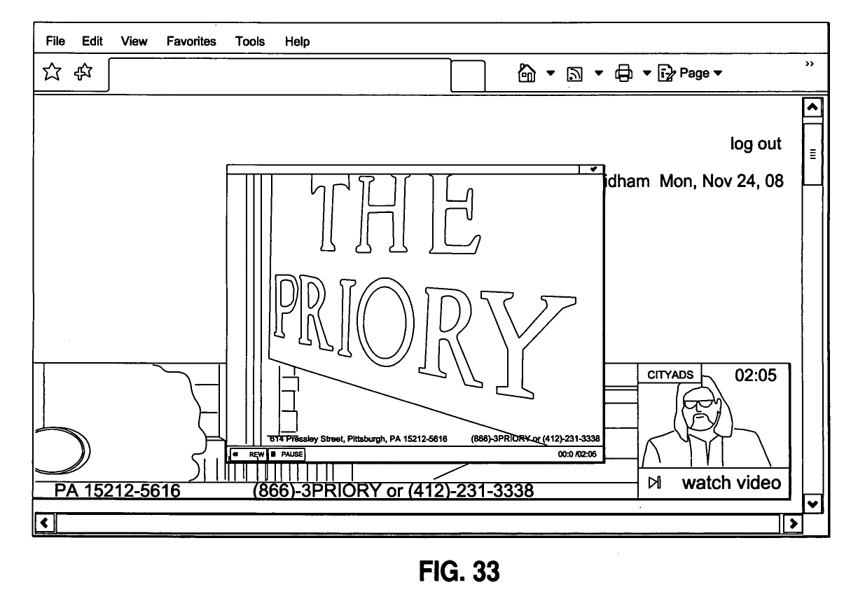

The system can be utilized to determine a viewer's browser window dimensions and scrolling position to provide content scaled to size to better fit the viewer's browser window by including scaling factor reduction or enlargement based on the system server side application's comparison of the designated content page rendering area for the content and the viewer's browser window dimensions and scrolling position as determined by the correlator code. FIG. 31 depicts a sample content page using the system to determine viewer browser screen dimensions and scrolling position to provide scaled rendering of content. FIG. 32 depicts a sample content page showing content rendered scaled to a predefined size in relation to the viewer's browser window dimensions and scrolling position. FIG. 33 depicts a sample content page showing content re-rendered and re-scaled to a predefined size in relation to modified viewer browser window dimensions and/or scrolling position.

Also, the system in a preferred embodiment may estimate or forecast content page/content page area inventory availability for future specified periods helping content publisher optimally sell and fill their content space inventory. Based on tracking data retrieved for a specific time period regarding content page/page area usage, the system can estimate activity for future time periods.

A sample of the JavaScript tag/link that is placed on the content page that links to the system server-side software application when a viewer first requests a content page is provided below: <script language=“javascript” type=“text/javascript” src=“http://cityads.net/ display/?key=waCcZO4I1GInZjIdFQdSELCe4PcWdeXgGXkMuaWqUPs%3d”></script>

A sample of a correlator code dynamically written to or otherwise embedded on the content page which functions to control the rendering of content based on whether the content page triggering area is within, or within a pre-defined distance outside of, the viewer's browser window dimensions and scrolling position, is provided below:

```
    var _viz_check = {
  xs1:0,
  ys1:0,
  xs2:1000,
  ys2:800,
  curtop:0,
  curleft:0,
  navigate:function( )
  {
    if( this.location[0]==“top” ) this.location[0]=“bottom”;
    else this.location[0]=“top”;
  },
  update:function( )
  {
    this.xs1 = this.getScrollLeft( );
    this.ys1 = this.getScrollTop( );
    this.xs2 = Number(this.xs1)+Number(this.getClientWidth( ));
    this.ys2 = Number(this.ys1) +Number(this.getClientHeight( ));
    var i=0;
    while ( i < _i )
      {
        var adi = _adi[i];
        if( adi != null)
          {
            adi.findPos( );
            var x1 = adi.x;
            var y1 = adi.y;
            var x2 = Number(x1)+Number(adi.width);
            var y2 = Number(y1)+Number(adi.height);
            var vm = 20 ;
            //  if (Number(adi.height) > 500) vm = 220 ;
            if ( adi.done==0 ) {
              if ((x2>=this.xs1)&&(y2>=this.ys1)&&(x1<=this.xs2)&&(y1<=this.ys2) ) {
                if ( (_popul==0) || (typeof [u_popul] != ‘undefined’) ) {
                  _popul++ ;
                  adi.markwords = _marksfinder.get_words( );
                  adi.ea = _ea_list ;
                  adi.populate( );
                }
              }
            } else {
            if (adi.rend==1) {
              if ( (x1>=(this.xs1−20))&&(y1>=(this.ys1−
vm))&&(x2<=(this.xs2+20))&&(y2<=(this.ys2+vm)) ) {
                if (adi.vid==0) {
                  if (adi.viz==0) {
                    if (adi.t >=1) {
                      adi.sec = 1;
                      _av(i,1) ;
                    }
                  }
                  else {
                    if ((adi.sec +1.1) <= adi.t) {
                      adi:sec ++ ;
                      if (adi.sec < 61) _av(i, adi.sec) ;
                    }
                    if (adi.paused==1) {
                      adi.paused=0 ;
                      _pv(i) ;
                    }
                  }
                  adi.t += 0.1 ;
                }
              }
              else {
                if (adi.paused==0) {
                  adi.paused=1 ;
                  _sv(i) ;
                }
              }
            }
          }
        }
        i++;
    }
  },
  findPos:function(p)
  {
    curleft = curtop = 0;
    var obj = document.getElementById(p) ;
    if (obj.offsetParent) {
      curleft = obj.offsetLeft
      curtop = obj.offsetTop
      while (obj = obj.offsetParent) {
        curleft += obj.offsetLeft
        curtop += obj.offsetTop
      }
    }
  },
  //---
  getClientWidth:function( ) {
    var w1=0;
    if( window.innerWidth ) w1=window.innerWidth;
    var w2=0;
    if(document.documentElement) w2 = document.documentElement.clientWidth;
    if(w1<w2) w1=w2;
    return w1;
  },
  getClientHeight:function( ) {
    var h1 = 0;
    if( window.innerHeight ) h1 = window.innerHeight;
    var h2=0;
    if( document.documentElement ) h2=document.documentElement.clientHeight;
    if(h1<h2) h1=h2;
    return h1;
  },
  getScrollLeft:function( ) {
    var sL1=0;
    if( window.pageXOffset ) sL1 = window.pageXOffset;
    var sL2=0;
    if(document.documentElement) sL2=document.documentElement.scrollLeft;
    if(sL1<sL2) sL1=sL2;
    return sL1;
  },
  getScrollTop:function( ) {
    var sT1=0;
    if(window.pageYOffset) sT1=window.pageYOffset;
    var sT2=0;
    if(document.documentElement) sT2=document.documentElement.scrollTop;
    if(sT1<sT2) sT1=sT2;
    return sT1;
  },
}
```

A sample of the code dynamically written to the content page that indexes the web page text for the most frequently occurring words is as follows:

```
var _index = {
  exc:[ “and”, “com”, “can”, “from”,“for”,“the”, “them”, “that”,
    “gif”, “similar”, “page”, “www”, “with”,“which”, “hi”,
    “you”,“your”,“did”,“does” ],
  top_max:5,
  top:[“”,“”,“”,“”,“”],
  get_words:function( )
  {
    var s = “”;
    for( var i=0; i<this.top_max; i++)
      {
        if( this.top[i]==“” ) break;
        if(s.length>0) s += “,”;
        s += this.top[i];
      }
      return encodeURI(s);
    },
    find_words:function( )
    {
      try{
        try{
          a=var_words;
        }
        catch(e1)
        {
          var txt = document.body.innerHTML.toLowerCase( );
          var sn = txt.split(/\<\s*script/);
          for(var i=0; i<sn.length;i++)
            {
              var n = sn[i].search( /\<s*\/scripts*\>/ );
              if(n==−1) n=0;
              var m = sn[i].indexOf(“>”,n)+1;
              sn[i] = sn[i].substring(m);
            }
            txt = sn.join(“ ”);
            var tst_msg = document.getElementById(‘tst_msg’);
            txt = txt.replace(/(\<[\hat{ }\>]*\>)/g, “ ”);
            txt = txt.replace(/(&.*\;)/g, “ ”);
            txt = txt.replace(/[\W\d]/g,“ ”);
            txt = txt.replace(/\s{1,}/g,“ ”);
            txt = txt.replace(/\s\w\w\w\s/g,“ ”);
            txt = txt.replace(/\s\w\w\s/g,“ ”);
            txt = txt.replace(/\s\w\s/g,“ ”);
            txt = txt.replace(/ies\s/g,“y ”);
            txt = txt.replace(/ives\s/g,“fe ”);
            txt = txt.replace(/ves\s/g,“f”);
            txt = txt.replace(/([\hat{ }s])s\s/g,“$1 ”);
            for(j=0;j<this.exc.length;j++)
              {
                var ex = new RegExp( “\\s”+this.exc[j]+“\\s”, “g”);
                txt = txt.replace( ex,“ ”);
              }
              var w = txt.split(/\s+/);
              w = w.sort( );
              var t=“”, to=“”;
              var k=1;
              w = w.sort( );
              var ktop=[0,0,0,0,0];
              while(w.length>0)
                {
                  t = w.shift( );
                  if( t==to ) k++;
                  if(t!=to || w.length==0 )
                    {
                      for(j=0;j<5;j++)
                        {
                          if(k>ktop[j]){ this.top[j]=to;
                          ktop[j]=k;break;}
                        }
                        k=1;
                        to = t;
                      }
                    }
                  }
                }
              catch( e )
              {
            document.write( “Exception” +e.description+“<br>” );
          }
        }
      }
```

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative and other embodiments may be selected without departing from the spirit and scope of the present invention.

What is claimed is:

1. A system for controlling the rendering of content via an electronic communications network at a designated content rendering area of a content page to one or more viewers having a network communications device with a browser software application with adjustable window dimensions and scrolling position, for perceiving content pages within said browser's window dimensions and scrolling position, comprising:
a system-end computer equipped and configured for communications via said electronic communications network, including one or more computer processing units and means for, communicating with one or more content pages that have one or more of said content rendering areas and one or more content page triggering areas on said pages, and a system server including a database that stores one or more records containing data pertaining to said one or more content pages, said one or more content page triggering areas, said one or more content page rendering areas and said one or more content files,
one or more content file servers which house one or more content files,
one or more network communications interface software applications for receiving from system users data designating one or more content pages, one or more content page rendering areas within said one or more content pages, one or more content page triggering areas that, when determined to be within a content page viewer's browser window dimensions and scrolling position, will result in content being rendered in said content page rendering area, and one or more content files for rendering at said one or more designated content rendering areas of said one or more content pages; and for creating a record, for storage in said system server database, that contains said data, assigning an identification code to said data record and generating a tag/link to be placed on said one or more content pages, said tag/link including a reference to said data record identification code and a link to a system custom software application; and
one or more system custom software applications for generating and writing to said designated content page a correlator code to determine when said designated content page triggering area is within a content viewer's browser window dimensions and scrolling position, for dynamically generating HTML code to be used as a marker for said designated content page rendering area, and for communicating with said correlator code to cause said one or more content files to be rendered in said one or more content page rendering areas when said correlator code detects that said designated content page triggering area is within said content viewer's browser window dimensions and scrolling position.

2. The system of claim 1, wherein said system software applications further include a content rendering module software application that is embedded at said specified content page rendering area when said correlator code determines that said specified content page triggering area is within the dimensions and scrolling position of said viewer's browser window and communicates with said one or more content servers to retrieve and render content files at said specified content page rendering area.

3. The system of claim 1, wherein said correlator code retrieves content rendering activity data from said viewer's browser, and further comprising a tracking server for communicating with said correlator code at said content page and said system server for storage of content rendering activity data.

4. The system of claim 2, wherein said content rendering module receives content rendering activity data from said correlator code and further comprising a tracking server for communicating with said content rendering module at said content page and said system server for storage of said content rendering activity data.

5. The system of claim 2, wherein said content rendering activity data is sent from said content rendering module to said system server via file server direct connection communication.

6. The system of claim 4, wherein said content rendering activity data is sent from said content rendering module to said tracking server via file server direct connection communication.

7. The system of claim 1, wherein said one or more content page rendering areas within said one or more content pages and said one or more content page triggering areas are the same areas.

8. The system of claim 1, wherein said content page triggering area has positional coordinates, said viewer's browser window dimensions and scrolling position have positional coordinates, and said correlator code determines when said designated content page triggering area is within a content viewer's browser window dimensions and scrolling position by determining whether there is correspondence between the positional coordinates of said content page triggering area and the positional coordinates of said viewer's browser window dimensions and scrolling position.

9. The system of claim 1, wherein said network comprises one or more networks selected from the group consisting of local area computer networks, wide area computer networks, the Internet, cable communications networks, satellite communications networks, television frequency networks, radio frequency communications networks, powerline communications networks and cellular communications networks.

10. The system of claim 1, wherein said one or more content files to be rendered in said one or more content page areas are rendered when the said designated content page triggering area is partially within said content viewer's browser window dimensions and scrolling position.

11. The system of claim 1, further comprising one or more software applications for compilation and presentation of reports pertaining to content rendering activity data with respect to said one or more content page rendering areas of said one or more content pages.

12. The system of claim 11, wherein said reports pertaining to content rendering activity data further comprise reports comparing content rendering activity at content page rendering areas located within the same content page.

13. The system of claim 12, wherein said content page rendering areas within said same content page that are compared in said reports comprise one or more areas selected from the group consisting of the top of said content page, above the fold of said content page, below the fold of said content page and the bottom of said content page.

14. The system of claim 11, wherein said reports comprise data pertaining to how long said content was rendered to said viewer at said content page rendering area.

15. The system of claim 11, wherein said reports comprise data pertaining to the number of said viewers to whom said content was rendered at said content page rendering area.

16. The system of claim 11, wherein said reports comprise data pertaining to the geographic location of said viewers to whom said content was rendered at said content page area.

17. The system of claim 11, wherein said reports comprise data pertaining to browser versions used by said viewers to whom said content was rendered at said content page area.

18. The system of claim 11, wherein said reports comprise data pertaining to how may times said content was rendered to said viewers at said content page rendering area.

19. The system of claim 11, wherein said reports comprise data pertaining to viewer click activity with respect to said content rendered to said viewers at said content page rendering area.

20. The system of claim 1, wherein said one or more system custom software applications further comprise means for creating a unique identification code that is assigned to each content viewer/browser.

21. The system of claim 20, wherein said means for creating a unique identification code that is assigned to each content viewer/browser comprises said correlator code.

22. A method for controlling the rendering of content via an electronic communication network on a content page rendering area of a content page based on determination of when a pre-defined area of said content page is within the browser window dimensions and scrolling position of a viewer's browser window, comprising the steps of:
designating one or more content pages, one or more content page areas and one or more content files, said content files being previously stored in electronic file format in a mass storage device of a computer system for rendering at said one or more designated content page areas of said one or more content pages;
storing as a record within a database data pertaining to said one or more content pages, said one or more content page rendering areas and said one or more content files;
generating and placing on said one or more designated content pages a tag/link that when activated by a content page viewer request for said designated content page, links to a system server-side application and retrieves, via said server-side application, data from said record stored in said system server-side database and data pertaining to said viewer and viewer browser from said content page request;
generating and writing a correlator code to said one or more designated content pages which determines whether said one or more designated content rendering areas of said one or more designated content pages is within said viewer's browser window dimensions and scrolling position and generates an HTML layer to serve as a marker for said one or more designated content page areas where said one or more designated content files are to be rendered;
generating a query string and link for placement at said one or more content pages, which when activated by said correlator code based on detection that one of said one or more designated content page areas is within the dimensions and scrolling position of said viewer's browser window, dynamically generates HTML codes and tags to render said one or more designated content files in said one or more content page rendering areas of said one or more content pages.

23. The method of claim 22, further comprising the step of designating one or more content page triggering areas which are different from said one or more content page rendering areas, which when within said viewer's browser window dimensions and scrolling position, trigger rendering of said one or more content files at said one or more content page rendering areas.

24. The method of claim 22, wherein said electronic communications network comprises one or more networks selected from the group consisting of local area computer networks, wide area computer networks, the Internet, cable communications networks, satellite communications networks, television frequency networks, radio frequency networks, powerline communications networks and cellular communications networks.

25. The method of claim 22, wherein said one or more content files to be rendered in said one or more content page areas are rendered when the said designated content page triggering area is partially within said content viewer's browser window dimensions and scrolling position.

26. The method of claim 22, further comprising the step of compiling and presenting reports pertaining to content rendering activity data with respect to said one or more content page rendering areas of said one or more content pages.

27. The method of claim 26, wherein said step of compiling and presenting reports further comprises comparing content rendering activity at content page rendering areas located within the same content page.

28. The method of claim 27, wherein said content page rendering areas within said same content page comprise one or more areas selected from the group consisting of the top of said content page, above the fold of said content page, below the fold of said content page and the bottom of said content page.

29. The method of claim 26, wherein said step of compiling and presenting reports further comprises compiling and presenting data pertaining to how long said content was rendered to said viewer at said content page rendering area.

30. The method of claim 26, wherein said step of compiling and presenting reports further comprises compiling and presenting data pertaining to the number of said viewers to whom said content was rendered at said content page rendering area.

31. The method of claim 26, wherein said step of compiling and presenting reports further comprises compiling and presenting data pertaining to the geographic location of said viewers to whom said content was rendered at said content page area.

32. The method of claim 26, wherein said step of compiling and presenting reports further comprises compiling and presenting data pertaining to browser versions used by said viewers to whom said content was rendered at said content page area.

33. The method of claim 26, wherein said step of compiling and presenting reports further comprises compiling and presenting data pertaining to how may times said content was rendered to said viewers at said content page rendering area.

34. The method of claim 26, wherein said step of compiling and presenting reports further comprises compiling and presenting data pertaining to viewer click through activity with respect to said content rendered to said viewers at said content page rendering area.

35. The method of claim 22, further comprising the step of creating and assigning a unique identification code to each content viewer/browser.

36. The method of claim 35, wherein said step of creating and assigning said unique identification code to each content viewer/browser is accomplished by said correlator code.

37. The method of claim 35, wherein said step of creating and assigning said unique identification code to each content viewer/browser is accomplished by said system server-side application.

38. A system for the control of content rendering via an electronic communications network at one or more content pages having one or more content page rendering areas, to one or more content page viewers having means for communicating via said electronic communications network and having a browser with one or more window dimensions and scrolling positions, comprising:
a system-end computer equipped and configured for network communications, including one or more computer processors and communicating with said one or more content pages and a server including a database that stores one or more records containing parameters and commands for rendering one or more content files at one or more specified content rendering areas of said one or more content pages,
one or more network communications interface software applications for interfacing with system users and for creating a record in said server database that contains parameters and commands to retrieve, assemble and display said one or more content files at said one or more designated content rendering areas, and
one or more system software applications for generating code for placement at said designated one or more content pages which, when one of said content page rendering areas is within the dimensions and scrolling position of said viewer's browser screen, causes said parameter and command record for said content page rendering area to be activated, thereby retrieving said content files and assembling and displaying said content at said content rendering area and retrieving from said viewer's browser data pertaining to said content rendering activity.

39. The system of claim 38, further comprising a tracking server communicating with said content page and said system server for storage of said content rendering data retrieved from said viewer's browser and said content page.

40. The system of claim 38, wherein said one or more content page rendering areas each have positional coordinates and said viewer's one or more browser window dimensions and scrolling positions each have positional coordinates, and said code is written to said content page and determines whether said positional coordinates of said content page rendering area correspond with said positional coordinates of said viewer's browser window dimensions and scrolling position, and triggers content rendering at said content rendering area when said correspondence is determined to exist.

41. A system for controlling the rendering of content via an electronic communications network at a designated content rendering area of a content page to one or more viewers having a network communications device with a browser software application with adjustable window dimensions and scrolling position, for perceiving content pages within said browser's window dimensions and scrolling position, comprising:
a system-end computer equipped and configured for communications via said electronic communications network, including one or more computer processing units and means for communicating with one or more content pages that have one or more of said content rendering areas and one or more content page triggering areas on said pages, and a system server including a database that stores one or more records containing data pertaining to said one or more content pages, said one or more content page triggering areas, said one or more content page rendering areas and said one or more content files,
one or more content file servers which house one or more content files,
one or more network communications interface software applications for receiving from system users data designating one or more content pages, one or more content page rendering areas within said one or more content pages, one or more content page triggering areas that, when determined to be within a pre-defined distance outside of a content page viewer's browser window dimensions and scrolling position, will result in content being rendered in said content page rendering area, and one or more content files for rendering at said one or more designated content rendering areas of said one or more content pages; and for creating a record, for storage in said system server database, that contains said data, assigning an identification code to said data record and generating a tag/link to be placed on said one or more content pages, said tag/link including a reference to said data record identification code and a link to a system custom software application; and
one or more system custom software applications for generating and writing to said designated content page a correlator code to determine when said designated content page triggering area is within said pre-defined distance outside of a content viewer's browser window dimensions and scrolling position, for dynamically generating HTML code to be used as a marker for said designated content page rendering area, and for communicating with said correlator code to cause said one or more content files to be rendered in said one or more content page rendering areas when said correlator code detects that said designated content page triggering area is within said pre-defined distance outside of said content viewer's browser window dimensions and scrolling position.

42. The system of claim 41, wherein said system software applications further include a content rendering module software application that is embedded at said specified content page rendering area and which communicates with said system server and said correlator code and which, when said specified content page triggering area is within said pre-defined distance outside of the dimensions and scrolling position of said viewer's browser window, causes said content files to be retrieved from said one or more content servers and rendered at said specified content page rendering area.

43. The system of claim 41, wherein said one or more content page rendering areas within said one or more content pages and said one or more content page triggering areas are the same areas.

44. The system of claim 41, wherein said correlator code retrieves content rendering activity data from said viewer's browser and said content page, and further comprising a tracking server for communicating with said content page and said system server for storage of said content rendering activity data retrieved from said viewer's browser and said content page.

45. The system of claim 42, further comprising a tracking server for communicating with said content page and said system server for storage of content rendering activity data retrieved from said viewer's browser and said content page.

46. The system of claim 45, wherein said content rendering activity data is sent from said content rendering module to said system server via file server direct connection communication.

47. The system of claim 45, wherein said content rendering activity data is sent from said content rendering module to said tracking server via file server direct connection communication.

48. The system of claim 41, wherein said content page triggering area has positional coordinates, said pre-defined distance outside said viewer's browser window dimensions and scrolling position has positional coordinates, and said viewer's browser window dimensions and scrolling position have positional coordinates, and said correlator code determines when said designated content page triggering area is within said pre-defined distance outside of a content viewer's browser window dimensions and scrolling position by determining whether there is correspondence between the positional coordinates of said content page triggering area and the positional coordinates of said area that is said pre-defined distance outside said viewer's browser window dimensions and scrolling position.

49. The system of claim 41, wherein said network comprises one or more networks selected from the group consisting of local area computer networks, wide area computer networks, the Internet, cable communications networks, satellite communications networks, television frequency networks, radio frequency communications networks, powerline communications networks and cellular communications networks.

50. The system of claim 44, further comprising one or more software applications for compilation and presentation of reports pertaining to content rendering activity data with respect to said one or more content page rendering areas of said one or more content pages.

51. The system of claim 44, wherein said content rendering activity data retrieved via said correlator code comprises data pertaining to content rendering activity at content page rendering areas located within the same content page.

52. The system of claim 51, wherein said content page rendering areas within said same content page comprise one or more areas selected from the group consisting of the top of said content page, above the fold of said content page, below the fold of said content page and the bottom of said content page.

53. The system of claim 44, wherein said content rendering activity data retrieved via said correlator code comprises one or more of the data selected from the group consisting of how long said content was rendered to said viewer at said content page rendering area, the number of said viewers to whom said content was rendered at said content page rendering area, the geographic location of said viewers to whom said content was rendered at said content page area, browser versions used by said viewers to whom said content was rendered at said content page area, how may times said content was rendered to said viewers at said content page rendering area, and viewer click activity with respect to said content rendered to said viewers at said content page rendering area.

54. The system of claim 41, wherein said one or more system custom software applications further comprise means for creating a unique identification code that is assigned to each content viewer/browser.

55. The system of claim 54, wherein said means for creating a unique identification code that is assigned to each content viewer/browser comprises said correlator code.

56. A method for controlling the rendering of content on a content page rendering area of a content page based on determination of when a pre-defined area of said content page is within a pre-defined distance outside of the browser window dimensions and scrolling position of a viewer's browser window via an electronic communications network, comprising the steps of:
designating one or more content pages, one or more content page areas and one or more content files, said content files being previously stored in electronic file format in a mass storage device of a computer system for rendering at said one or more designated content page areas of said one or more content pages;
storing as a record within a system-side database data pertaining to said one or more content pages, said one or more content page rendering areas and said one or more content files;
generating and placing at said one or more designated content pages a tag/link that when activated by a content page viewer request for said designated content page, links to a system server-side application and retrieves, via said server-side application, data from said record stored in said system server-side database and data pertaining to said viewer and viewer browser from said content page request;
generating and writing a correlator code to said one or more designated content pages which determines whether said one or more designated content rendering areas of said one or more designated content pages is within a pre-defined distance outside of said viewer's browser window dimensions and scrolling position and generates an HTML layer to serve as a marker for said one or more designated content page areas where said one or more designated content files are to be rendered;
generating a query string and link for placement at said one or more content pages, which when activated by said correlator code based on detection that one of said one or more designated content page areas is within said pre-defined distance outside of the dimensions and scrolling position of said viewer's browser window, dynamically generates HTML codes and tags to render said one or more designated content files in said one or more content page rendering areas of said one or more content pages.

57. The method of claim 56, further comprising the step of designating one or more content page triggering areas which are different from said one or more content page rendering areas, which when within said pre-defined distance outside of said viewer's browser window dimensions and scrolling position, trigger rendering of said one or more content files at said one or more content page rendering areas.

58. The method of claim 56, further comprising the step of compiling and presenting reports pertaining to content rendering activity data with respect to said one or more content page rendering areas of said one or more content pages.

59. The method of claim 56, further comprising the step of creating and assigning a unique identification code to each content viewer/browser.

60. The method of claim 59, wherein said step of creating and assigning said unique identification code to each content viewer/browser is accomplished by said correlator code.

61. The method of claim 59, wherein said step of creating and assigning said unique identification code to each content viewer/browser is accomplished by said system server-side application.
